(19) United States
(12) Patent Application Publication
(10) Pub. No.: US 2013/0301733 A1
(43) Pub. Date: Nov. 14, 2013

(54) IMAGE PROCESSING DEVICE AND METHOD

(71) Applicant: Kazushi Sato, Tokyo (JP)

(72) Inventor: Kazushi Sato, Tokyo (JP)

(73) Assignee: Sony Corporation, Tokyo (JP)

(21) Appl. No.: 13/978,508

(22) PCT Filed: Jan. 6, 2012
(86) PCT No.: PCT/JP2012/050171

§ 371 Date: Jul. 5, 2013

(30) Foreign Application Priority Data
Jan. 13, 2011 (JP) 2011-005187

(51) Int. Cl. H04N 7/36

(52) U.S. Cl. CPC H04N 19/00696
USPC 375/240.16

(57) ABSTRACT

The present technology relates to an image processing device and method able to improve encoding efficiency. An image processing device includes a predictor prediction unit predicting a predictor used in the current block from information of a predictor used in a peripheral block positioned in the periphery of the current block which is an encoding process target; a prediction image generation unit generating a prediction image of the current block using a predictor of the current block predicted by the predictor prediction unit; and a decoding unit decoding encoded data in which an image is encoded using a prediction image generated by the prediction image generation unit. The present technology may be applied to, for example, to an image processing device.

### TECHNICAL FIELD

The present disclosure relates to an image processing device and method, and more particularly, to an image processing device and method able to improve encoding efficiency.

### BACKGROUND ART

In recent years, devices compliant with methods such as MPEG (Moving Picture Experts Group) treating image information digitally, in this case, having an object of highly efficient information transmission and storage, using the characteristic redundancy of image information, and compressing the information through orthogonal transform, such as discrete cosine transform, and motion compensation, have come into wide spread use in both information distribution, such as broadcast stations, and information reception, such as in ordinary households.

In particular, MPEG2 (ISO (International Organization for Standardization)/IEC (International Electrotechnical Commission) 13818-2) is defined as a general purpose image encoding method, is a standard encompassing both interlaced scanning images and sequential scanning images, together with standard resolution images and high definition images, and is currently widely used across a wide range of applications in professional usage and consumer usage. Through the MPEG2 compression method, a high compression rate and good picture quality are able to be realized by allocating an encoding rate (bit rate) of 4 to 8 Mbps for an interlaced scanning image with a standard resolution having 720×480 pixels and 18 to 22 Mbps for an interlaced scanning image with high resolution having 1920×1088 pixels.

MPEG2 is mainly targeted at high image quality encoding adapted to broadcasting; however, does not correspond to an encoding method with an encoding amount (bit rate) lower than MPEG1, in other words, with a higher compression rate. Due to the widespread use of portable terminals, it is thought that the need for such an encoding method will increase in the future, and standardization of the MPEG4 encoding method was performed corresponding thereto. Regarding image encoding methods, the specification thereof was approved as an international standard as ISO/IEC 14496-2 in December 1998.

Furthermore, in recent years, standardization of the standard known as H.26L (ITU-T (International Telecommunication Union Telecommunication Standardization Sector) Q6/16 VCEG (Video Coding Expert Group)) has progressed with an object of image encoding for teleconferencing. Although a greater computation amount for encoding and decoding is demanded for H.26L compared to the MPEG2 or MPEG4 encoding methods of the related art, it is known that higher encoding efficiency is realized. In addition, at present, as a part of the activity of MPEG4, standardization incorporating functions not supported in H.26L, and realizing higher encoding efficiency is being performed as the Joint Model of Enhanced-Compression Video Coding, with H.26L as a base.

As a standardization schedule, H.264 and MPEG-4 Part 10 (Advanced Video Coding, hereinafter referred to as AVC) became international standards under these names in March, 2003.

Incidentally, appropriately using either of a “Temporal Predictor” and a “Spatio-Temporal Predictor”, added to a “Spatial Predictor” defined in AVC and required by the median prediction as prediction motion vector information, is proposed in order to improve the encoding of a motion vector using a median prediction in AVC (for example, refer to NPL 1).

In an image information encoding device, the cost function is calculated in a case of using the respective prediction motion vector information regarding the respective blocks, and selection of the optimal predicted motion vector information is performed. In the image compression information, flag information showing information relating to which prediction motion vector information is used with respect to the respective blocks is transmitted.

Incidentally, there is concern that setting a macroblock size to 16 pixels×16 pixels may not be optimal with respect to a large image frame in UHD (Ultra High Definition; 4000 pixels×2000 pixels) that is a target of a next generation encoding method.

Thereby, at present, as an object of further improvements in encoding efficiency over AVC, standardization of the encoding method known as HEVC (High Efficiency Video Coding) by the JCTVC (Joint Collaboration Team-Video Coding), which is a joint standardization team of the ITU-T and the ISO/IEC, is progressing (for example, refer to NPL 2).

In the HEVC encoding method, a coding unit (CU (coding unit)) as a processing unit similar to a macroblock in AVC is defined. The CU is specified in image compression information in the respective sequence, and not fixed to a size of 16×16 pixels as in an AVC macroblock.

The CU is hierarchically configured from the largest LCU (Largest Coding Unit) to the smallest SCU (Smallest Coding Unit). In other words, in general, the LCU corresponds to an AVC macroblock, and a CU lower in the hierarchy than the LCU (CU smaller than the LCU) may be thought of as corresponding to a submacroblock in AVC.

Incidentally, as one method of encoding motion information, a technique known as Motion Partition Merging has been proposed (for example, refer to NPL 3). In this technique, two flags known as a Merge_Flag and a Merge_Left_Flag are transmitted.

When Merge_Flag=1, the motion information of the current block X is the same as the motion information of the block T or the block L, and at this time, the Merge_Left_Flag is transmitted in image compression information which becomes output.

When this value is 0, the motion information of the current block X differs from both block T and block L, and the motion information relating to block X is transmitted to the image compression information.

In a case where Merge_Flag=1 and Merge_Left_Flag=1, the motion information of the current block X becomes the same as the motion information of the block L.

In a case where Merge_Flag=1 and Merge_Left_Flag=0, the motion information of the current block X becomes the same as the motion information of the block L.

The above-described Motion Partition Merging is proposed as a substitute for Skip in AVC.

### Citation List

### Non Patent Literature

NPL 1: Joel Jung, Guillaume Laroche, “Competition-Based Scheme for Motion Vector Selection and Coding”, VCEG-AC06, ITU-Telecommunications Standardization Sector STUDY GROUP 16 Question 6 Video Coding Experts Group (VCEG) 29th Meeting: Klagenfurt, Austria, 17-18 July, 2006
NPL 2: “Test Model under Consideration”, JCTVC-B205, Joint Collaborative Team on Video Coding (JCT-VC) of ITU-T SG16 WP3 and ISO/IEC JT C1/SC29/WG11 2nd Meeting: Geneva, CH, 21-28 July, 2010
NPL 3: Martin Winken, Sebastian Bosse, Benjamin Bross, Philipp Helle, Tobias Hinz, Heiner Kirchhoffer, Haricharan Lakshman, Detlev Marpe, Simon Oudin, Matthias Preiss, Heiko Schwarz, Mischa Siekmann, Karsten Suchring, and Thomas Wiegand, “Description of video coding technology proposed by Fraunhofer HHI”, JCTVC-A116, April, 2010

### SUMMARY OF INVENTION

### Technical Problem

However, as in Citation 1, when an encoding process is performed on motion vector information using a plurality of prediction modes (predictor), the amount of information relating to which prediction mode (predictor) to use for each block increases, and there is concern of a lowering of the encoding efficiency.

The present disclosure, taking the above circumstances into account, enables improvement in encoding efficiency by obtaining which prediction mode (predictor) is used for the current block using the correlation between the current block and a peripheral block, in a case of performing an encoding process of a motion vector information using motion vector competition.

### Solution to Problem

One aspect of the present invention is an image processing device including: a predictor prediction unit predicting a predictor used in a current block from information of a predictor used in a peripheral block positioned in the periphery of the current block which is an encoding process target; a prediction image generation unit generating a prediction image of the current block using a predictor of the current block predicted by the predictor prediction unit; and a decoding unit decoding encoded data in which an image is encoded using a prediction image generated by the prediction image generation unit.

The peripheral block may include an adjacent block adjacent to the current block.

The adjacent block may include an upper adjacent block adjacent to the upper portion of the current block, and a left adjacent block adjacent to the left portion of the current block.

The adjacent block may further include an upper left adjacent block adjacent to the upper left portion of the current block, or an upper right adjacent block adjacent to the upper right portion of the current block.

The peripheral block further may further include a Co-located block positioned Co-located with the current block.

The predictor prediction unit may set the predictor with the smallest index within the predictor of the peripheral block to the prediction result of the predictor of the current block.

The predictor prediction unit, in a case where a part of a peripheral block is not present, may predict the predictor of the current block using only the predictor of present peripheral blocks, and in a case where all peripheral blocks are not present, may skip prediction of the predictor of the current block.

The predictor prediction unit may predict the predictor of the current block using only a predictor of peripheral block with a size matching or approximating the current block, and may skip prediction of the predictor of the current block in a case where a size of all peripheral blocks does not match and does not approximate the current block.

The predictor prediction unit, in a case where a part of the peripheral block is encoded using a MergeFlag, may predict the predictor of the current block using an index signifying motion information of a peripheral block different to a merged peripheral block.

The predictor prediction unit, in a case where the peripheral block is intra encoded, may predict the predictor of the current block with a code number with respect to a predictor of the peripheral block as 0.

Another aspect of the present disclosure is an image processing method of an image processing device, the method including: causing a predictor prediction unit to predict a predictor used in the current block from information of a predictor used in a peripheral block positioned in the periphery of the current block which is an encoding process target; causing a prediction image generation unit to generate a prediction image of the current block using the predictor of the predicted current block; and causing a decoding unit to decode encoded data in which an image is encoded using a generated prediction image.

Another aspect of the present disclosure is an image processing device including: a predictor prediction unit predicting a predictor used in the current block from information of a predictor used in a peripheral block positioned in the periphery of the current block which is an encoding process target; a prediction image generation unit generating a prediction image of the current block using the predictor of the current block predicted by the predictor prediction unit; and an encoding unit encoding an image using a prediction image generated by the prediction image generation unit.

The peripheral block may include an adjacent block adjacent to the current block.

The adjacent block may include an upper adjacent block adjacent to the upper portion of the current block, and a left adjacent block adjacent to the left portion of the current block.

The adjacent block may further include an upper left adjacent block adjacent to the upper left portion of the current block, or an upper right adjacent block adjacent to the upper right portion of the current block.

The peripheral block further may further include a Co-located block positioned Co-located with the current block.

The predictor prediction unit may set the predictor with the smallest index within the predictor of the peripheral block to the prediction result of the predictor of the current block.

The predictor prediction unit, in a case where a part of a peripheral block is not present, may predict the predictor of the current block using only the predictor of present peripheral blocks, and in a case where all peripheral blocks are not present, may skip prediction of the predictor of the current block.

The predictor prediction unit may predict the predictor of the current block using only a predictor of a peripheral block with a size matching or approximating the current block, and may skip prediction of the predictor of the current block in a case where a size of all peripheral blocks does not match and does not approximate the current block.

The predictor prediction unit, in a case where a part of the peripheral block is encoded using a MergeFlag, may predict the predictor of the current block using an index signifying motion information of a peripheral block different to a merged peripheral block.

The image processing device may further include a comparison unit comparing a predictor with respect to the current block and a predictor predicted by the predictor prediction unit; and a flag information generation unit generating flag information representing a comparison result by the comparison unit.

The encoding unit may encode the flag information generated by the flag information generating unit together with the information related to predictor predicted by the predictor prediction unit, or the difference between a predictor predicted by the predictor prediction unit and a predictor with respect to the current block.

The predictor prediction unit, in a case where the peripheral block is intra encoded, may predict the predictor of the current block with a code number with respect to a predictor of the peripheral block as 0.

Another aspect of the present disclosure is an image processing method of an image processing device, the method including: causing a predictor prediction unit to predict a predictor used in the current block from information of a predictor used in a peripheral block positioned in the periphery of the current block which is an encoding process target; causing a prediction image generation unit to generate a prediction image of the current block using the predictor of the predicted current block; and causing an encoding unit to encode an image using a generated prediction image.

According to the aspect of the present disclosure, a predictor used in the current block is predicted from information of a predictor used in a peripheral block positioned in the periphery of the current block which is an encoding process target; a prediction image of the current block is generated using the predictor of the predicted current block; and encoded data in which an image is encoded may be decoded using the generated prediction image.

In the aspect of the present disclosure, a predictor used in the current block is predicted from information of a predictor used in a peripheral block positioned in the periphery of the current block which is an encoding process target; a prediction image of the current block is generated using the predictor of the predicted current block; and an image is encoded using the generated prediction image.

### Advantageous Effects of Invention

According to the present disclosure, an image may be processed. In particular, the encoding efficiency may be improved.

### BRIEF DESCRIPTION OF DRAWINGS

FIG. 1 is a block diagram showing an image encoding device outputting image compression information based on the AVC encoding method.

FIG. 2 is a block diagram showing an image decoding device inputting image compression information based on the AVC encoding method.

FIG. 3 is a diagram showing an example of a motion prediction and compensation process with a decimal point pixel precision.

FIG. 4 is a diagram showing an example of a macroblock.

FIG. 5 is a diagram describing an example of a condition of a median operation.

FIG. 6 is a diagram describing an example of a multi-reference frame.

FIG. 7 is a diagram describing an example of a condition of a temporal direct mode.

FIG. 8 is a diagram describing an example of a condition of a motion vector encoding method proposed in NPL 1.

FIG. 9 is a diagram describing a configuration example of a coding unit.

FIG. 10 is a diagram describing an example of a condition of Motion Partition Merging proposed in NPL 3.

FIG. 11 is a block diagram showing a main configuration example of an image encoding device.

FIG. 12 is a block diagram showing a main configuration example of a motion prediction and compensation unit and a motion information prediction unit of FIG. 11.

FIG. 13 is a diagram describing an operating principle of the motion information prediction unit.

FIG. 14 is a diagram describing an example of a method predicting a correlation between adjacent blocks.

FIG. 15 is a flowchart describing an example of the flow of an encoding process.

FIG. 16 is a flowchart describing an example of the flow of an inter motion prediction process.

FIG. 17 is a block diagram showing a main configuration example of an image decoding device.

FIG. 18 is a block diagram showing a main configuration example of a motion prediction and compensation unit and a motion information prediction unit of FIG. 17.

FIG. 19 is a flowchart describing an example of the flow of a decoding process.

FIG. 20 is a flowchart describing an example of the flow of a prediction process.

FIG. 21 is a flowchart describing an example of the flow of an inter prediction process.

FIG. 22 is a block diagram showing a main configuration example of personal computer.

FIG. 23 is a block diagram showing a main configuration example of a television receiver.

FIG. 24 is a block diagram showing a main configuration example of portable telephone.

FIG. 25 is a block diagram showing a main configuration example of a hard disk recorder.

FIG. 26 is a block diagram showing a main configuration example of a camera.

### DESCRIPTION OF EMBODIMENTS

Hereinafter, embodiments for realizing the present technology (below, referred to as “embodiments”) will be described. Further, the description will be given in the following order.

### 1. First Embodiment (Image Encoding Device)

### 2. Second Embodiment (Image Decoding Device)

### 3. Third Embodiment (Personal Computer)

### 4. Fourth Embodiment (Television Receiver)

### 5. Fifth Embodiment (Portable Telephone)

### 6. Sixth Embodiment (Hard Disk Recorder)

### 7. Seventh Embodiment (Camera)

### 1. First Embodiment

### Image Encoding Device of AVC Encoding Method

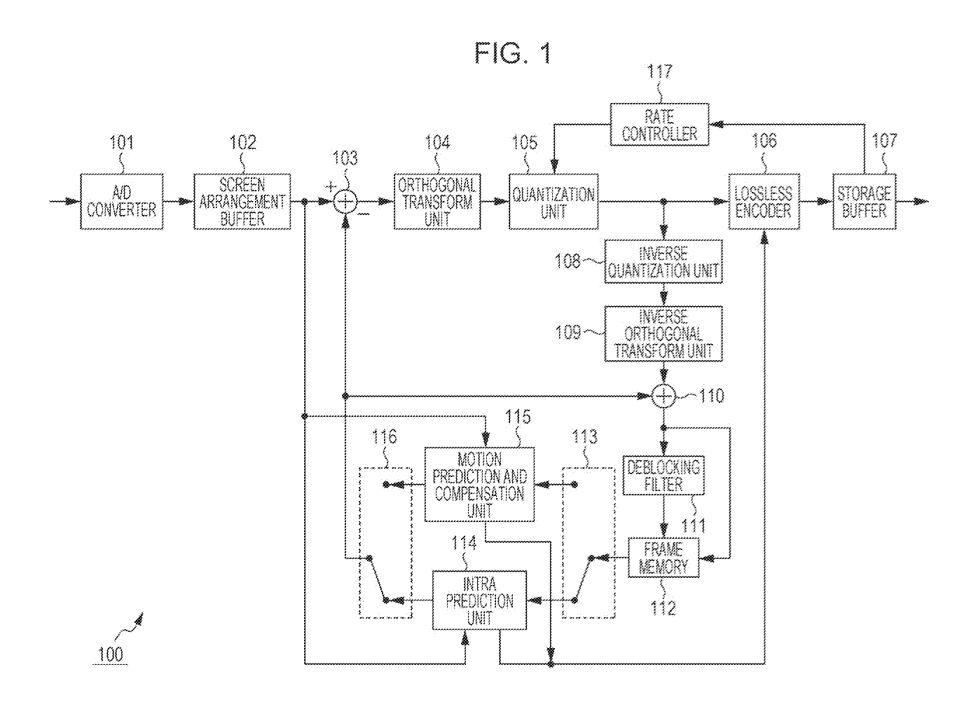

FIG. 1 illustrates a configuration of a first embodiment of an image encoding device encoding an image using the H.264 and MPEG (Motion Picture Experts Group) 4 Part 10 (AVC (Advance Video Coding)) encoding methods.

The image encoding device 100 shown in FIG. 1 is a device encoding and outputting images using an encoding method based on the AVC standard. As shown in FIG. 1, the image encoding device 100 includes an A/D converter 101, screen arrangement buffer 102, a computation unit 103, an orthogonal transform unit 104, a quantization unit 105, a lossless encoder 106, and a storage buffer 107. In addition, the image encoding unit 100 includes an inverse quantization unit 108, an inverse orthogonal transform unit 109, a computation unit 110, a deblocking filter 111, a frame memory 112, a selection unit 113, an intra prediction unit 114, a motion prediction and compensation unit 115, a selection unit 116 and a rate controller 117.

The A/D converter 101 performs A/D conversion on input image data and outputs and stores the data to a screen arrangement buffer 102. The screen arrangement buffer 102 arranges a stored image with frames in display order to a frame order for encoding according to a GOP (Group of Picture) structure. The screen arrangement buffer 102 provides an image with an arranged frame order to the computation unit 103. In addition, the screen arrangement buffer 102 also provides the image with an arranged frame order to the intra prediction unit 114 and the motion prediction and compensation unit 115.

The computation unit 103 subtracts a prediction image provided from the intra unit prediction unit 114 or the motion prediction and compensation unit 115 via the selection unit 116 from the image read out from the screen arrangement buffer 102, and outputs the difference information thereof to the orthogonal transform unit 104.

For example, in a case of an image on which intra encoding is performed, the computation unit 103 subtracts a prediction image provided from the intra prediction unit 114 from the image read out from the screen arrangement buffer 102. In addition, for example, in a case of an image on which inter encoding is performed, the computation unit 103 subtracts a prediction image provided from the motion prediction and compensation 115 from an image read out from the screen arrangement buffer 102.

The orthogonal transform unit 104 performs an orthogonal transform such as a discrete cosine transform and a Karhunen-Loeve Transform with respect to the difference information provided from the computation unit 103, and provides the transform coefficient thereof to the quantization unit 105.

The quantization unit 105 quantizes the transform coefficient output by the orthogonal transform unit 104. The quantization unit 105 sets quantization parameters based on information relating to a target value of an encoding rate provided from the rate controller 117 and performs quantization. The quantization unit 105 provides the quantized transform coefficient to the lossless encoder 106.

The lossless encoder 106 performs a lossless encoding, such as variable-length character encoding and arithmetic coding, with respect to the quantized transform coefficient. Since the coefficient data is quantized under control of the rate controller 117, the encoding rate becomes the target value set by the rate controller 117 (or approaches the target value).

The lossless encoder 106 acquires information or the like indicating the intra prediction from the intra prediction unit 114, and acquires information indicating an inter prediction mode or motion vector information from the motion prediction and compensation unit 115. Moreover, the information indicating the intra prediction (prediction within a screen) is also referred to as intra prediction mode information below. In addition, the information indicating the information mode indicating an inter prediction (prediction between screens) is also referred to as inter prediction mode information below.

The lossless encoder 106 sets various types of information, such as a filter coefficient, intra prediction mode information, inter prediction mode information and quantization parameters as a portion of header information of the encoded data (performs multiplexing), and encodes the quantized transform coefficient. The lossless encoder 106 provides and stores the encoded data obtained by encoding in the storage buffer 107.

For example, a lossless encoding process, such as variable length encoding or arithmetic coding, is performed in the lossless encoder 106. Examples of the variable length encoding include CAVLC (Context-Adaptive Variable Length Coding) prescribed in the H.264/AVC method, or the like. Examples of the arithmetic encoding include CABAC (Context-Adaptive Binary Arithmetic Coding) or the like.

The storage buffer 107 temporarily holds encoded data provided from the lossless encoder 106, and, at a predetermined timing, outputs the data as an encoded image encoded using the H.264/AVC to a latter stage recording device or transmission path, or the like, not shown in the drawings.

In addition, the transform coefficient quantized in the quantization unit 105 is also provided to the inverse quantization unit 108. The inverse quantization unit 108 performs inverse quantization of the quantized transform coefficient using a method corresponding to the quantization by the quantization unit 105. The inverse quantization unit 108 provides the obtained transform coefficient to the inverse orthogonal transform unit 109.

The inverse orthogonal transform unit 109 performs an inverse orthogonal transform on the provided transform coefficient using a method corresponding to the orthogonal transform process by the orthogonal transform unit 104. The inverse orthogonally transformed output (restored difference information) is provided to the computation unit 110.

The computation unit 110 adds the prediction image provided via the selection unit 116 from the intra prediction unit 114 or the motion prediction and compensation unit 115 to the inverse orthogonal transform results, that is, the restored difference information, provided by the inverse orthogonal transform unit 109 and obtains a locally decoded image (decoded image).

For example, in a case in which difference information corresponds to an image on which intra encoding is performed, the computation unit 110 adds the prediction image provided from the intra prediction unit 114 to the difference information. In addition, for example, in a case in which difference information corresponds to an image on which inter encoding is performed, the computation unit 110 adds the prediction image provided from the motion prediction and compensation unit 115 to the difference information.

The addition results are provided to the deblocking filter 111 or the frame memory 112.

The deblocking filter 111 removes the blocking effects of the decoded image by performing an appropriate deblocking filter process. The deblocking filter 111 provides the filter processing results to the frame memory 112. Moreover, the decoded image output from the computation unit 110 may be provided to the frame memory 112 without passing through the deblocking filter 111. In other words, it is possible to not perform the deblocking filter process of the deblocking filter 111.

The frame memory 112 stores the provided decoded image, and, at a predetermined timing, outputs the stored decoded image as a reference image via the selection unit 113 to the intra prediction unit 114 or the motion prediction and compensation unit 115.

For example, in a case of an image on which intra encoding is performed, the frame memory 112 provides a reference image to the intra prediction unit 114 via the selection unit 113. In addition, for example, in a case in which inter encoding is performed, the frame memory 112 provides a reference image to the motion prediction and compensation unit 115 via the selection unit 113.

In a case where the reference image provided from the frame memory 112 is an image on which intra encoding is performed, the selection unit 113, the reference image is provided to the intra prediction unit 114. In addition, in a case where the reference image provided from the frame memory 112 is an image on which inter encoding is performed, the selection unit 113 provides the reference image to the motion prediction and compensation unit 115.

The intra prediction 114 performs an intra prediction (prediction within screen) generating a prediction image using pixel values within a processing target picture provided from the frame memory 112 via the selection unit 113. The intra prediction unit 114 performs the intra prediction using a plurality of modes (intra prediction modes) prepared in advance.

In the H.264 image information encoding method, an intra 4×4 prediction mode, an intra 8×8 prediction mode and an intra 16×16 prediction mode are defined with respect to the luminance signal, and, in addition, a prediction mode independent of the luminance signal may be defined for each of the respective macroblocks with respect to a color difference signal. Regarding the intra 4×4 prediction mode, one intra prediction mode is defined with respect to the respective 4×4 luminance blocks; regarding the intra 8×8 mode, one intra prediction mode is defined with respect to the respective 8×8 luminance blocks. With respect to the intra 16×16 mode and the color difference signal, one prediction mode is defined with respect to one macroblock.

The intra prediction unit 114 generates a prediction image using all of the intra prediction modes serving as candidates, evaluates the cost relation value of each prediction image using the input image provided from the screen arrangement buffer 102, and selects the optimal mode. The intra prediction unit 114 selects the optimal intra prediction mode, and provides an image generated with the optimal mode to a computation unit 103 or computation unit 110 via the selection unit 116.

In addition, as described above, the intra prediction unit 114 provides information, such as intra prediction mode information indicating the intra prediction mode employed, to the appropriate lossless encoder 106.

The motion prediction and compensation unit 115, with regard to an image on which inter encoding is performed, performs motion prediction (inter prediction) using an input image provided from the screen arrangement buffer 102 and a reference image provided from the frame memory 112 via the selection unit 113, performs a motion compensation process according to a detected motion vector, and generates a prediction image (inter prediction image information). The motion prediction and compensation unit 115 performs such inter prediction using a plurality of modes (inter prediction modes) prepared in advance.

The motion prediction and compensation unit 115 generates a prediction image using all of the inter prediction modes serving as candidates, evaluates the cost relation value of each prediction image, and selects the optimal mode. The motion prediction and compensation unit 115 provides the generated prediction image to the computation unit 103 or the computation unit 110 via the selection unit 116.

In addition, the motion prediction and compensation unit 115 provides inter prediction mode information indicating the inter prediction mode employed or motion vector information indicating the calculated motion vector to the lossless encoder 106.

The selection unit 116, in a case of an image on which intra encoding is performed, provides the output of the intra prediction unit 114 to the computation unit 103 or the computation unit 110, and, in a case of an image on which inter encoding is performed, provides the output of the motion prediction and compensation unit 115 to the computation unit 103 or computation unit 110.

The rate controller 117, regarding a compressed image stored in the storage buffer 107, controls the rate of the quantization operation of the quantization unit 105 such that an overflow or underflow does not occur.

### [AVC Encoding Method Image Decoding Device]

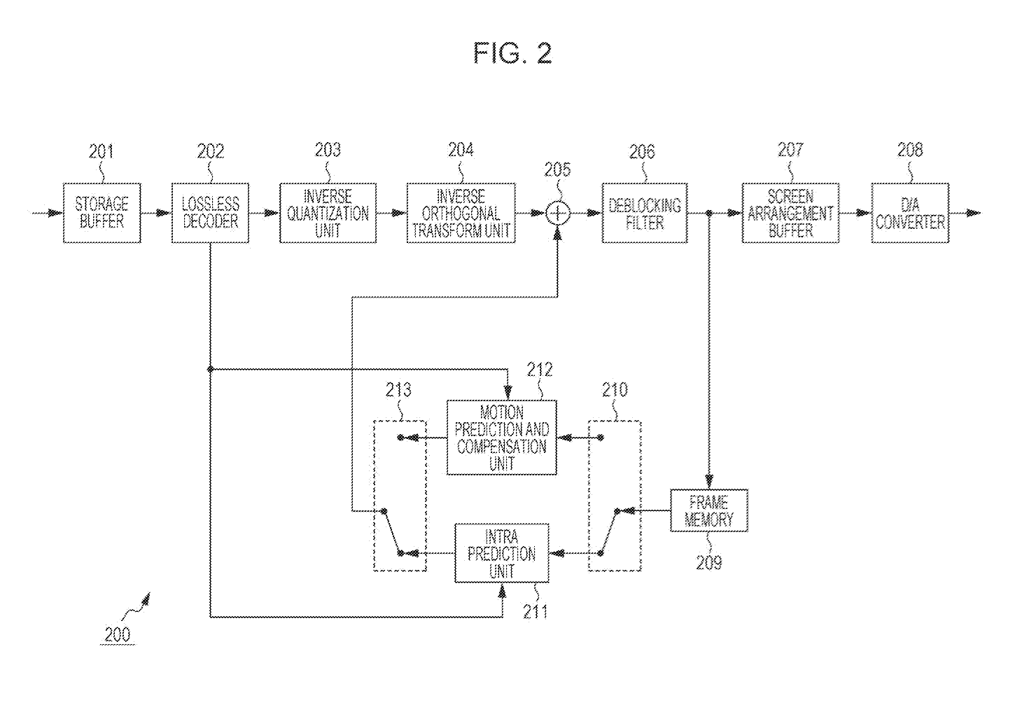

FIG. 2 is a block diagram showing a main configuration example of an image decoding device realizing image compression through an orthogonal transform, such as a discrete cosine transform or Karhunen-Loeve Transform, and motion compensation. The image decoding device 200 shown in FIG. 2 is a decoding device corresponding to the image encoding device 100 of FIG. 1.

The encoded data encoded by the image encoding device 100 is provided via, for example, an arbitrary route, such as a transmission path or a recording medium, to the image decoding device 200 corresponding to the image encoding device 100, and is decoded.

As shown in FIG. 2, the image decoding device 200 includes a storage buffer 201, a lossless decoder 202, an inverse quantization unit 203, an inverse orthogonal transform unit 204, a computation unit 205, a deblocking filter 206, and screen arrangement buffer 207 and a D/A converter 208. In addition, the image decoding device 200 includes a frame memory 209, a selection unit 210, an intra prediction unit 211, a motion prediction and compensation unit 212 and a selection unit 213.

The storage buffer 201 stores transmitted encoded data. The encoded data is encoded by the image encoding device 100. The lossless encoder 202 decodes data read out at a predetermined timing from the storage buffer 201 using a method corresponding to the encoding method of the lossless encoder 106 of FIG. 1.

In addition, in a case where the current frame is intra encoded, intra prediction mode information is accommodated in the header portion of the encoded data. The lossless decoder 202 also decodes the intra prediction mode information and provides the information to the intra prediction unit 211. In contrast, in a case where the current frame is inter encoded, motion vector information is accommodated in the header portion of the encoded data. The lossless decoder 202 decodes the motion vector information and provides the information to the motion prediction and compensation unit 212.

The inverse quantization unit 203 performs inverse quantization of coefficient data (quantized coefficient) obtained by decoding by the lossless decoder 202 using a method corresponding to the quantization method of the quantization unit 105 of FIG. 1. In other words, the inverse quantization unit 203 performs inverse quantization of the quantization coefficient using a similar method to the inverse quantization unit 108 of FIG. 1.

The inverse quantization unit 203 provides coefficient data subjected to inverse quantization, that is, orthogonal transform coefficient, to the inverse orthogonal transform unit 204. The inverse orthogonal transform unit 204 performs an inverse orthogonal transform of the orthogonal transform coefficient using a method corresponding to the inverse transform method of the inverse transform unit 104 of FIG. 1 (the same method as the inverse transform unit 109 of FIG. 1) and obtains decoded residual data corresponding to residual data before the orthogonal transform is performed in the image encoding device 100. For example, a fourth order inverse orthogonal transform is performed.

The decoded residual data obtained by performing the inverse orthogonal transform is provided to the computation unit 205. In addition, in the computation unit 205, a prediction image is provided from the intra prediction unit 211 or the motion prediction and compensation unit 212 via the selection unit 213.

The computation unit 205 adds the decoded residual data and the prediction image, and obtains the decoded image data corresponding to image data before the prediction image is subtracted by the computation unit 103 of the image encoding unit 100. The computation unit 205 provides the decoded image data to the deblocking filter 206.

The deblocking filter 206 provides the data to the screen arrangement buffer 207 after removing the blocking effect of the provided decoded image.

The screen arrangement buffer 207 performs arrangement of the image. In other words, the order of the frames arranged for the encoding order by the screen arrangement buffer 102 of FIG. 1 is arranged in the original display order. The D/A converter 208 performs D/A conversion on the image provided from the screen arrangement buffer 207, and outputs and displays the image on a display not shown in the diagrams.

The output of the deblocking filter 206 is further provided to the frame memory 209.

The frame memory 209, the selection unit 210, the intra prediction unit 211, the motion prediction and compensation unit 212 and the selection unit 213 correspond respectively to the frame memory 112, the selection unit 113, the intra prediction unit 114, the motion prediction and compensation unit 115 and the selection unit 116 of the image encoding device 100.

The selection unit 210 reads out an image on which an inter process is performed and a referenced image from the frame memory 209, and provides these to the motion prediction and compensation unit 212. In addition, the selection unit 210 reads out an image used in intra prediction from the frame memory 209 and provides this to the intra prediction unit 211.

In the intra prediction unit 211, information or the like indicating the intra prediction mode obtained by decoding header information is appropriately provided from the lossless decoder 202. The intra prediction unit 211 generates, based on the information, a prediction image from the reference image acquired from the frame memory 209, and provides the generated prediction image to the selection unit 213.

The motion prediction and compensation unit 212 acquires information (such as prediction mode information, motion vector information, reference frame information, flags and various parameters) obtained by decoding header information from the lossless decoder 202.

The motion prediction and compensation unit 212 generates, based on the information provided from the lossless decoder 202, a prediction image from the reference image acquired from the frame memory 209, and provides the generated prediction image to the selection unit 213.

The selection unit 213 selects a prediction image generated by the motion prediction and compensation unit 212 or the intra prediction unit 211, and provides the image to the computation unit 205.

### [Decimal Pixel Accuracy of Motion Prediction and Compensation Process]

Incidentally, in encoding methods such as MPEG2, a motion prediction and compensation process with a ½ pixel accuracy is performed by a linear interpolation process; however, in the AVC encoding method, a motion prediction and compensation process with a ¼ pixel accuracy is performed using a 6-tap FIR filter, and thereby encoding efficiency is improved.

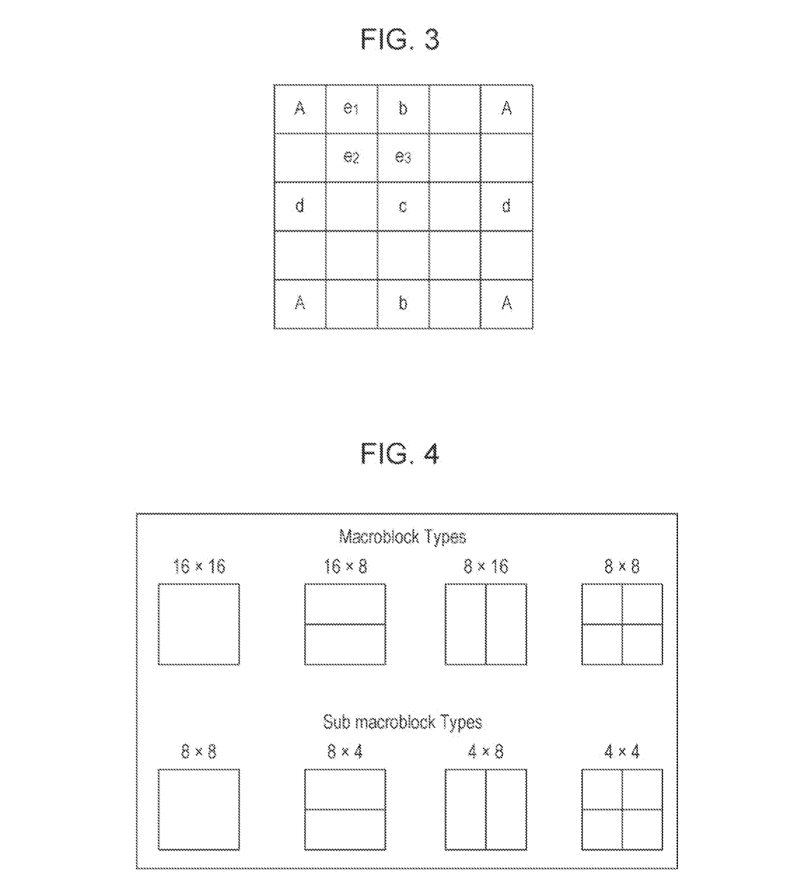

FIG. 3 is a diagram describing an example of a condition of a ¼ pixel accuracy stipulated in the AVC encoding method. In FIG. 3, each square indicates a pixel. In the diagram, A indicates a position with an integer accuracy pixel accommodated in the frame memory 112, b, c, and d indicate a position with a ½ pixel accuracy, and e₁, e₂ and e₃ indicate a position with a ¼ pixel accuracy.

Below, the function Clip1 ( ) is defined as in the following Expression (1).

$$\begin{matrix}[ Equation 1 ] & \\ Clip 1 ( a ) = \{ \begin{matrix}0 ; if ( a < 0 ) \\ a ; otherwise \\ max\_pix ; if ( a > max\_pix )\end{matrix} & ( 1 )\end{matrix}$$

For example, in a case of the input image having an 8 bit accuracy, the value of max_pix in Expression (1) becomes 255.

The pixel values in the positions of b and d are generated as in the following Expression (2) and Expression (3) using a 6-tap FIR filter.

[Equation 2]

F=A₋₂−5·A₋₁+20·A₀+20·A₁−5·A₂+A₃ (2)

[Equation 3]

b, d=Clip1((F+16)>>5) (3)

The pixel value in the position of c is generated as in the following Expression (4) to Expression (6) applying a 6-tap FIR filter in the horizontal and vertical directions.

[Equation 4]

F=b₋₂−5·b₋₁+20·b₀+20·b₁−5·b₂+b₃ (4), or

[Equation 5]

F=d₋₂−5·d₋₁+20·d₀+20·d₁−5·d₂+d₃ (5)

[Equation 6]

c=Clip1((F+512)>>10) (6)

Moreover, the Clip process is finally performed only one time after the product-sum process is performed in both the horizontal and vertical directions.

e₁ to e₃ are generated through linear interpolation as in the following Expression (7) to Expression (9).

[Equation 7]

e₁=(A+b+1)>>1 (7)

[Equation 8]

e₂=(b+d+1)>>1 (8)

[Equation 9]

e₃=(b+c+1)>>1 (9)

### [Motion Prediction and Compensation Process]

In addition, in MPEG2, the unit of motion prediction and compensation processing is 16×16 pixels in a case of a frame motion compensation mode, and motion prediction and compensation processing is performed as units of 16×8 pixels with respect to a first field and a second field in the case of a field motion compensation mode.

In contrast, in AVC, as shown in FIG. 4, one macroblock configured by 16×16 pixels is divided into partitions of any of 16×16, 16×8, 8×16 or 8×8, and it is possible to have mutually independent motion vector information for each submacroblock. Furthermore, an 8×8 partition, as shown in FIG. 4, may be divided into submacroblocks of any of 8×8, 8×4, 4×8 or 4×4, and it is possible to have mutually independent motion vector information.

However, in the AVC image encoding method, similarly to the case of MPEG2, when such a motion prediction and compensation process is performed, there is concern of extensive motion vector information being generated. And there is concern that the encoding efficiency may be lowered when the generated motion vector information is encoded as is.

### [Median Prediction of Motion Vector]

As a method of solving such problems, in the AVC image encoding, a reduction in the encoding information of a motion vector is realized using the method below.

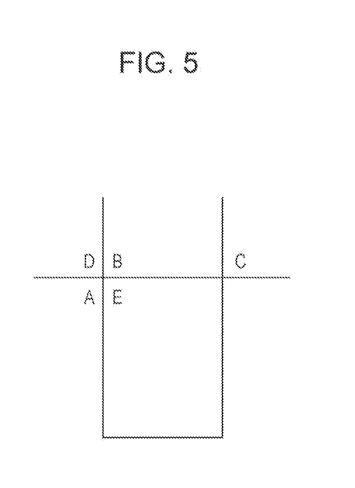

Each straight line shown in FIG. 5 indicates the boundary of motion compensation blocks. In addition, in FIG. 5, E represents the current motion compensation block to be encoded hereafter, A to D respectively indicate motion compensation blocks adjacent to E for which encoding is already completed.

Here, the motion vector information is set to mvₓ with respect to X, as X=A, B, C, D, and E.

First, prediction motion vector information pmv_{E} with respect to motion compensation block E is generated using motion vector information regarding motion compensation blocks A, B and C by a median operation as in the following Expression (10).

[Equation 10]

pmv_{E}=med(mv_{A}, mv_{B}, mv_{C}) (10)

The information regarding the motion compensation block D may be substituted in a case where the information regarding the motion compensation block C is “unavailable” due to reasons of being at the edge of the image frame, or the like.

In the image compression information, the data mvd_{E} encoded as motion vector information with respect to the motion compensation block E is generated using pmv_{E} as in the following Expression (11).

[Equation 11]

mvd_{E}=mv_{E}−pmv_{E} (11)

Moreover, for an actual process, the processes are independently performed with respect to the respective horizontal direction and vertical direction components of the motion vector information.

### [Multi-Reference Frame]

In addition, a method known as Multi-Reference Frame (multi (plural) reference frames) not stipulated in image encoding systems of the related art, such as MPEG2 or H.263 is stipulated in AVC.

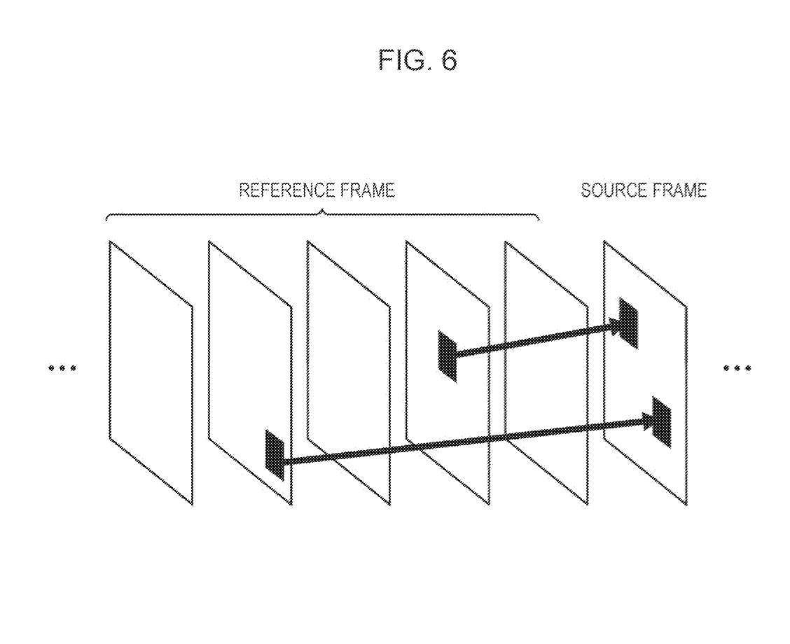

Using FIG. 6, Multi-reference frames (Multi-Reference Frame) stipulated in AVC will be described.

That is, in MPEG-2 or H.263, motion prediction and compensation is performed by referencing only one reference frame accommodated in the frame memory in the case of a P picture; however, in AVC, as shown in FIG. 5, plural reference frames are accommodated in the memory and it is possible to reference a different memory for each macroblock.

### [Direct Mode]

Incidentally, the amount of information in motion vector information in a B picture is extensive; however, in AVC, a mode known as Direct Mode (direct mode) is prepared.

In this direct mode (Direct Mode), the motion vector information is not accommodated in the image compression information. In an image decoding device, the motion vector information of the current block is calculated from motion vector information of a peripheral block or a co-located block which is a block in the same position as a processing target block in a reference frame.

In the direct mode (Direct Mode), there are two types of a Spatial Direct Mode (spatial direct mode) and a Temporal Direct Mode (temporal direct mode) and these may be switched for each slice.

In the spatial direct mode (Spatial Direct Mode), the movement vector information mv_{E} of the processing target movement compensation block E is calculated as shown in the following Expression (12).

mv_{E}=pmv_{E} (12)

In other words, the motion vector information generated by a Median (median) prediction is applied to the current block.

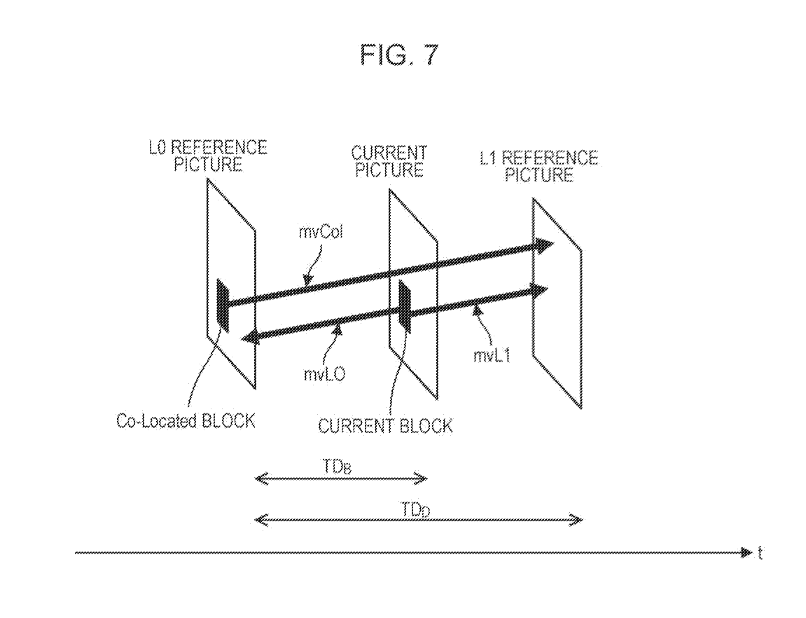

Below, the temporal direct mode (Temporal Direct Mode) will be described using FIG. 7.

In FIG. 7, in the L0 reference picture, a block in the same spatial address as the current block is set as a Co-Located block, and the motion vector information in the Co-Located block is set as mv_{col}. In addition, the distance between the current picture and the L0 reference picture on the spatial axis is set to TD_{B}, and the distance between the L0 reference picture and the L1 reference picture on the spatial axis is set to TD_{D}.

At this time, in the current picture, the motion vector information mv_{L0} of L0 and the motion vector information mv_{L1} of L1 are calculated as in the following Expression (13) and Expression (14).

$$\begin{matrix}[ Equation 12 ] & \\ {mv}_{L 0} = \frac{{TD}_{B}}{{TD}_{D}} {mv}_{col} & ( 13 ) \\ [ Equation 13 ] & \\ {mv}_{L 1} = \frac{{TD}_{D} - {TD}_{B}}{{TD}_{D}} {mv}_{col} & ( 14 )\end{matrix}$$

Moreover, in the AVC image compression information, since there is no information TD representing a distance on the temporal axis, computation of the above Expression (12) and Expression (13) is performed using a POC (Picture Order Count).

In addition, in the AVC image compression information, the direct mode (Direct Mode) may define a 16×16 pixel macroblock unit or an 8×8 pixel macroblock unit.

### [Selection of Prediction Mode]

Incidentally, in the AVC encoding method, selection of an appropriate prediction mode is important in achieving a higher encoding efficiency.

Examples of the selection method may include methods implemented in H.264/MPEG-4 AVC reference software (disclosed at http://iphome.hhi.de/suchring/tml/index.htm) known as JM (Joint Model).

In the JM, described below, it is possible to select between two mode determination methods, a High Complexity Mode and a Low Complexity Mode. Whichever is selected, a cost relation value relating to each of the prediction modes is calculated, and the prediction mode for which this is the smallest is selected as the optimal mode with respect to the current submacroblock or the current macroblock.

The cost relation in the High Complexity Mode is represented as in the following Expression (15).

Cost(ModeεΩ)=D+λ*R (15)

Here, Ω is a universal set of candidate modes for encoding blocks and macroblocks; and D is the difference energy of the decoded image and the input image in the case of being encoded using the current prediction mode. λ is a Lagrange undetermined multiplier provided as a relation of a quantization parameter. R is the total encoding rate in the case of being encoded in the current mode, including the orthogonal transform coefficient.

That is, in performing encoding with the High Complexity Mode, there is a need for a provisional encoding process to be performed one using all of the candidate modes in order to calculate the parameters D and R, and a higher computation amount is needed.

The cost function in the Low Complexity Mode is represented as in the following Expression (16).

Cost(ModeεΩ)=D+QP2Quant(QP)×HeaderBit (16)

Here, different to the case of High Complexity Mode, D is the difference energy of the prediction image and the input image. QP2Quant (QP) is provided as a function of the quantization parameter QP; and HeaderBit is the encoding rate relating to information belonging to Header, such as the motion vector or mode, and does not include the orthogonal transform coefficient.

That is, in the Low Complexity Mode, there is a need to perform a prediction process regarding the respective candidate modes; however, there is no need to perform the encoding process, as the decoded image is not needed. Therefore, it is possible to realize a lower computation amount through the High Complexity Mode.

[Motion Vector Competition] Incidentally, as described referencing FIG. 5, in order to improve encoding of the motion vector using the median prediction, a method as described below is proposed in NPL 1.

In other words, in addition to the “Spatial Predictor (spatial prediction)” obtained through median prediction defined in AVC, it is possible to appropriately use either of a “Temporal Predictor (temporal prediction)” and a “Spatio-Temporal Predictor (time and space prediction)” described below as prediction motion vector information.

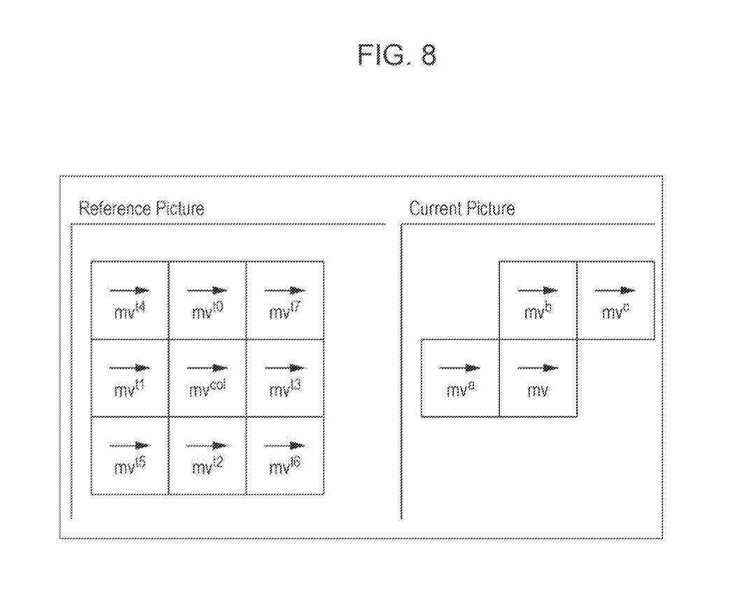

That is, in FIG. 8, the respective prediction motion vector information (Predictor) is defined by the following Expression (17) to Expression (19), with the motion vector information with respect to the co-located block (in the reference image, a block with the same xy coordinates as the current block) with respect to the current block as “mvcol” and the motion vector information of the peripheral block as mvtk (k=0 through 8).

Temporal Predictor:

[Equation 14]

mvₜₘ₅=median{mv_{col}, mvₜ₀, . . . , mvₜ₃} (17)

[Equation 15]

mvₜₘ₉=median{mv_{col}, mvₜ₀, . . . , mvₜ₈} (18)

Spatio-Temporal Predictor:

[Equation 16]

mvₛₚₜ=median{mv_{col}, mv_{col}, mvₐ, mv_{b}, mv_{c}} (19)

In the image information encoding device 100, the cost function is calculated in a case of using the respective prediction motion vector information regarding the respective blocks, and selection of the optimal predicted motion vector information is performed. In the image compression information, a flag showing information relating to which prediction motion vector information is used with respect to the respective blocks is transmitted.

### [Coding Unit]

Incidentally, setting a macroblock size to 16 pixels×16 pixels is not optimal with respect to a large image frame in UHD (Ultra High Definition; 4000 pixels×2000 pixels) that is a target of a next generation encoding method.

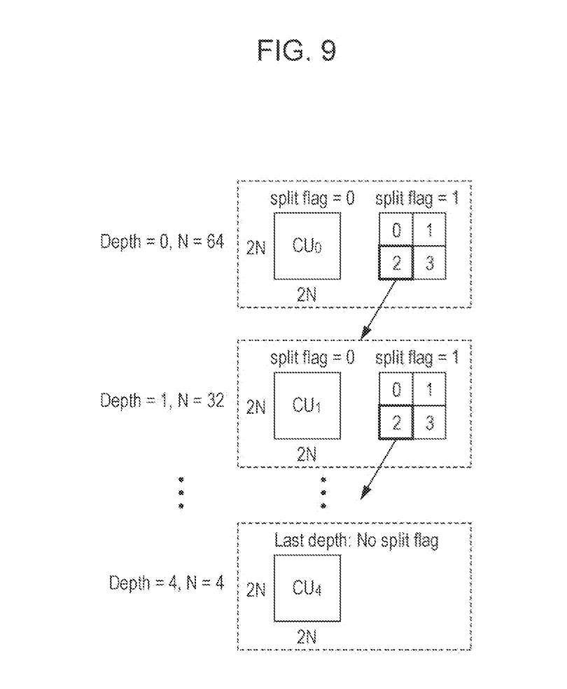

Herein, in AVC, as shown in FIG. 4, a hierarchical structure is stipulated by macroblocks and submacroblocks; however, for example, in HEVC (High Efficiency Video Coding), a coding unit (CU (Coding Unit)) is stipulated, as shown in FIG. 9.

The CU is also called a Coding Tree Block (CTB), and is a partial region of an image of a picture unit serving the same role as a macroblock in AVC. The latter is fixed to a size of 16×16 pixels, whereas the size of the former is fixed and is specified in the image compression information in the respective sequences.

For example, in a sequence parameter set (SPS (Sequence Parameter Set)) included in the encoding data which is the output, the maximum size (LCU (Largest Coding Unit)) and the minimum size (SCU (Smallest Coding Unit)) of the CU are stipulated.

Within the respective LCUs, by setting split-flag=1 within a range of not falling below the SCU size, division is possible into smaller size CUs. In the example of FIG. 9, the size of the LCU is 128, and the maximum hierarchical depth is 5. A CU with a size of 2N×2N is divided into a CU with a size of N×N and becomes one lower in the hierarchy when the value of split_flag is “1”.

Furthermore, the CU is divided into a prediction unit (Prediction Unit (PU)) which is a region (partial region of a picture unit of an image) which becomes a processing unit of intra or inter prediction, and in addition, is divided into a transform unit (Transform Unit (TU)) which is a region (partial region of a picture unit of an image) which becomes a processing unit of the orthogonal transform. Currently, in HEVC, in addition to 4×4 and 8×8, it is possible to use a 16×16 and 32×32 orthogonal transform.

As in the above HEVC, the CU is defined, and in the case performing various types of process such as an encoding method with the CU as a unit, the macroblocks in AVC may be considered as corresponding to LCU. However, since the CU includes a hierarchical structure as shown in FIG. 9, the size of the LCU in the highest hierarchical level is ordinarily set larger than the macroblock in AVC, such as, for example, 128×128 pixels.

### [Merge of Motion Partitions]

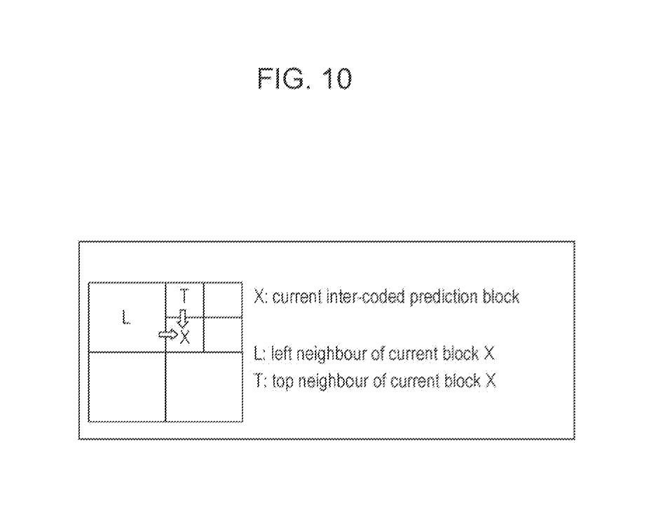

Incidentally, as one encoding method of motion information, a method known as Motion Partition Merging, such as shown in FIG. 10, is proposed in NPL 3. In this technique, two flags known as a Merge_Flag and a Merge_Left_Flag are transmitted.

When Merge_Flag=1, the motion information of the current block X is the same as the motion information of the block T or the block L, and at this time, the Merge_Left_Flag is transmitted in image compression information which becomes output. When this value is 0, the motion information of the current block X differs from both block T and block L, and the motion information relating to block X is transmitted to the image compression information.

In a case where Merge_Flag=1 and Merge_Left_Flag=1, the motion information of the current block X becomes the same as the motion information of the block L. In a case where Merge_Flag=1 and Merge_Left_Flag=0, the motion information of the current block X becomes the same as the motion information of the block L.

The above-described Motion Partition Merging is proposed as a substitute for Skip in AVC.

### [Regarding the Embodiment]

However, a plurality of predictors (predictor) as described above is prepared, when an encoding process is performed on a motion vector information by selecting the optimal one therefrom, there is a need for information relating to which prediction device (predictor) is used to be provided for each block; however, there is concern of the information amount increasing and the encoding efficiency decreasing.

Here, in the embodiment, it is possible for the information amount transmitted to the decoding side to be reduced, and for the reduction in the encoding efficiency to be suppressed by setting so as to predict the predictors (predictor) of the current region using the correlation between the current region and a peripheral region.

### [Image Encoding Device]

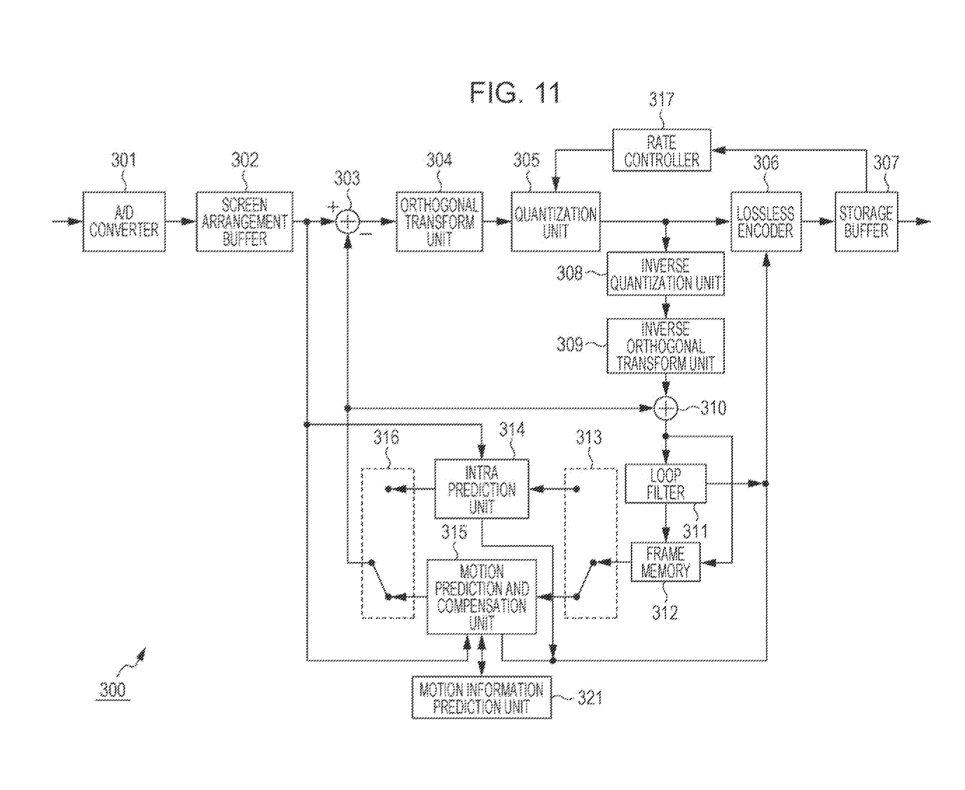

FIG. 11 is a block diagram showing a main configuration example of an image encoding device.

The image encoding device 300 shown in FIG. 11 is basically the same device as the image encoding device 100 of FIG. 1, and encodes image data. As shown in FIG. 11, the image encoding device 300 includes an A/D converter 301, screen arrangement buffer 302, a computation unit 303, an orthogonal transform unit 304, a quantization unit 305, a lossless encoder 306, and a storage buffer 307. In addition, the image encoding unit 300 includes an inverse quantization unit 308, an inverse orthogonal transform unit 309, a computation unit 310, a loop filter 311, a frame memory 312, a selection unit 313, an intra prediction unit 314, a motion prediction and compensation unit 315, a selection unit 316 and a rate controller 317.

The image encoding device 300 further includes a motion information prediction unit 321.

The A/D converter 301 performs A/D conversion on input image data. The A/D converter 301 provides image data after conversion (digital data) to the screen arrangement buffer 302 and causes the data to be stored. The screen arrangement buffer 302 arranges a stored image with frames in display order to a frame order for encoding according to GOP. The screen arrangement buffer 302 provides an image with an arranged frame order to the computation unit 303. In addition, the screen arrangement buffer 302 also provides the image with an arranged frame order to the intra prediction unit 314 and the motion prediction and compensation unit 315.

The computation unit 303 subtracts the prediction image provided from the intra prediction unit 314 or the motion prediction and compensation unit 315 via the selection unit 316 from the image read out from the screen arrangement buffer 302. The computation unit 303 outputs the difference information thereof to the orthogonal transform unit 304.

For example, in a case of an image on which intra encoding is performed, the computation unit 303 subtracts a prediction image provided from the intra prediction unit 314 from the image read out from the screen arrangement buffer 302. In addition, for example, in a case of an image on which inter encoding is performed, the computation unit 303 subtracts a prediction image provided from the motion prediction and compensation 315 from an image read out from the screen arrangement buffer 302.

The orthogonal transform unit 304 performs an orthogonal transform, such as a discrete cosine transform or a Karhunen-Loeve Transform with respect to difference information provided from the computation unit 303. Moreover, the method of the orthogonal transform is arbitrary. The orthogonal transform unit 304 provides the transform coefficient to the quantization unit 305.

The quantization unit 305 quantizes the transform coefficient provided from the orthogonal transform unit 304. The quantization unit 305 sets quantization parameters based on information relating to a target value of an encoding rate provided from the rate controller 317 and performs quantization thereof. Moreover, the method of quantization is arbitrary. The quantization unit 305 provides the quantized transform coefficient to the lossless encoder 306.

The lossless encoder 306 encodes with an arbitrary encoding method of the transform coefficient quantized in the quantization unit 305. Since the coefficient data is quantized under control of the rate controller 317, the encoding rate becomes the target value set by the rate controller 317 (or approaches the target value).

The lossless encoder 306 acquires information or the like indicating the intra prediction mode from the intra prediction unit 314, and acquires information indicating an inter prediction mode or motion vector information from the motion prediction and compensation unit 315. Further, the lossless encoder 306 acquires a filter coefficient or the like used in a loop filter 311.

The lossless encoder 306 encodes these various types of information using an arbitrary encoding method, and sets this as a part of the header information of encoded data (performs multiplexing). The lossless encoder 306 provides and stores the encoded data obtained by encoding in the storage buffer 307.

Examples of the encoding method of the lossless encoder 306 include, for example, variable-length character encoding or arithmetic coding. Examples of the variable length encoding include, for example, CAVLC (Context-Adaptive Variable Length Coding), or the like, prescribed in the H.264/AVC method. Examples of the arithmetic coding include, for example, CABAC (Context-Adaptive Binary Arithmetic Coding) or the like.

The storage buffer 307 temporarily holds encoded data provided from the lossless encoder 306. The storage buffer 307 outputs, at a predetermined timing, the held encoded data to a latter stage recording device (recording medium) or transmission path not shown in the drawing.

In addition, the transform coefficient quantized in the quantization unit 305 is also provided to the inverse quantization unit 308. The inverse quantization unit 308 performs inverse quantization of the quantized transform coefficient using a method corresponding to the quantization by the quantization unit 305. The method of inverse quantization may be any method if the method corresponds to the quantization process by the quantization unit 305. The inverse quantization unit 308 provides the obtained transform coefficient to the inverse orthogonal transform unit 309.

The inverse orthogonal transform unit 309 performs an inverse orthogonal transform on the transform coefficient provided from the inverse quantization unit 308 using a method corresponding to the orthogonal transform process by the orthogonal transform unit 304. The method of the inverse orthogonal transform may be any method if a method corresponding to the orthogonal transform process by the orthogonal transform unit 304. The inverse orthogonally transformed output (restored difference information) is provided to the computation unit 310.

The computation unit 310 adds the prediction image provided via the selection unit 316 from the intra prediction unit 314 or the motion prediction and compensation unit 315 to the inverse orthogonal transform results, that is, the restored difference information, provided by the inverse orthogonal transform unit 309 and obtains a locally decoded image (decoded image).

For example, in a case in which difference information corresponds to an image on which intra encoding is performed, the computation unit 310 adds the prediction image provided from the intra prediction unit 314 to the difference information. In addition, for example, in a case in which difference information corresponds to an image on which inter encoding is performed, the computation unit 310 adds the prediction image provided from the motion prediction and compensation unit 315 to the difference information.

The addition results (decoded image) are provided to the loop filter 311 or the frame memory 312.

The loop filter 311 performs an appropriate filtering process with respect to the decoded image provided from the computation unit 310, including deblock filtering or adaptive loop filtering, or the like. For example, the loop filter 311 removes a blocking effects of the decoded image by performing the same deblock filtering process as the deblock filter 111 with respect to the decoded image. In addition, for example, the loop filter 311 performs image quality improvement by performing a loop filtering process using a Weiner filter (Weiner Filter) with respect to the deblock filtering process results (decoded image on which blocking effect removal is performed).

Moreover, the loop filter 311 may perform an arbitrary filtering process with respect to the decoded image. In addition, the loop filter 311 provides information, such as a filter coefficient used in a filtering process, to the lossless encoder 306 as needed, and may cause this information to be encoded.

The loop filter 311 provides the filter processing results (decoded image after the filtering process) to the frame memory 312. Moreover, as described above, the decoded image output from the computation unit 310 may be provided to the frame memory 312 without passing through the deblocking filter 311. In other words, it is possible to not perform the filtering process using the loop filter 311.

The frame memory 312 stores the provided decoded image and provides the stored decoded image at a predetermined timing to the selection unit 313 as a reference image.

The selection unit 313 selects the provision destination of the reference image provided from the frame memory 312. For example, in the case of intra prediction, the selection unit 313 provides the reference image provided from the frame memory 312 to the intra prediction unit 314. In addition, in the case of inter prediction, the selection unit 313 provides the reference image provided from the frame memory 312 to the motion prediction and compensation unit 315.

The intra prediction unit 314 basically performs intra prediction (prediction within a screen) generating a prediction image with PU as a processing unit using the pixel value within a processing target picture which is a reference image provided from the frame memory 312 via the selection unit 313. The intra prediction unit 314 performed the intra prediction using a plurality of modes (intra prediction modes) prepared in advance. The intra prediction unit 314 is also able to perform intra prediction using an arbitrary method other than only the mode stipulated in the AVC encoding method.

The intra prediction unit 314 generates a prediction image using all of the intra prediction modes serving as candidates, evaluates the cost relation value of each prediction image using the input image provided from the screen arrangement buffer 102, and selects the optimal mode. The intra prediction unit 314, when selecting the optimal intra prediction mode, provides a prediction image generated with the optimal mode to the selection unit 316.

In addition, as described above, the intra prediction unit 314 provides information, such as intra prediction mode information indicating the intra prediction mode employed, to the appropriate lossless encoder 306, and causes the information to be encoded.

The motion prediction and compensation unit 315, performs motion prediction (inter prediction), basically with PU as a processing unit, using an input image provided from the screen arrangement buffer 302 and a reference image provided from the frame memory 312 via the selection unit 313, performs a motion compensation process according to a detected motion vector, and generates a prediction image (inter prediction image information). The motion prediction and compensation unit 315 performs such inter prediction using a plurality of modes (inter prediction modes) prepared in advance. The motion prediction and compensation unit 315 is also able to perform inter prediction using an arbitrary method other than only the mode stipulated in the AVC encoding method.

The motion prediction and compensation unit 315 generates a prediction image using all of the inter prediction modes serving as candidates, evaluates the cost relation value of each prediction image, and selects the optimal mode. The motion prediction and compensation unit 315, when selecting the optimal inter prediction mode, provides a prediction image generated with the optimal mode to the selection unit 316.

In addition, the motion prediction and compensation unit 315, when decoding information indicating the inter prediction mode employed or encoded data, provides information necessary for performing the process using the inter prediction mode to the lossless encoder 306 and causes the information to the encoded.

The selection unit 316 selects the provision source of the prediction image provided to the computation unit 303 or computation unit 310. For example, in the case of intra encoding, the selection unit 316 selects the intra prediction unit 314 as the provision source of the prediction image, and provides the prediction image provided from the intra prediction unit 314 to the computation unit 303 or computation unit 310. In addition, in the case of inter encoding, the selection unit 316 selects the motion prediction and compensation unit 315 as the provision source of the prediction image, and provides the prediction image provided from the motion prediction and compensation unit 315 to the computation unit 303 or computation unit 310.

The rate controller 317, regarding the encoding rate of the encoded data stored in the storage buffer 307, controls the rate of the quantization operation of the quantization unit 305 such that an overflow or underflow does not occur.

The motion information prediction unit 321 performs a process predicting the motion vector of the processing target current PU within the inter prediction of the motion prediction and compensation unit 315 using information of a peripheral PU which is a PU of the periphery (adjacent to or in the vicinity of) of the current PU.

The method of prediction (that is, predictor (Predictor)) is arbitrary, and may be a mode stipulated in AVC or a mode proposed in the above-described NPLs, or may be an arbitrary method other than these.

### [Motion Prediction and Compensation Unit and Motion Information Prediction Unit]

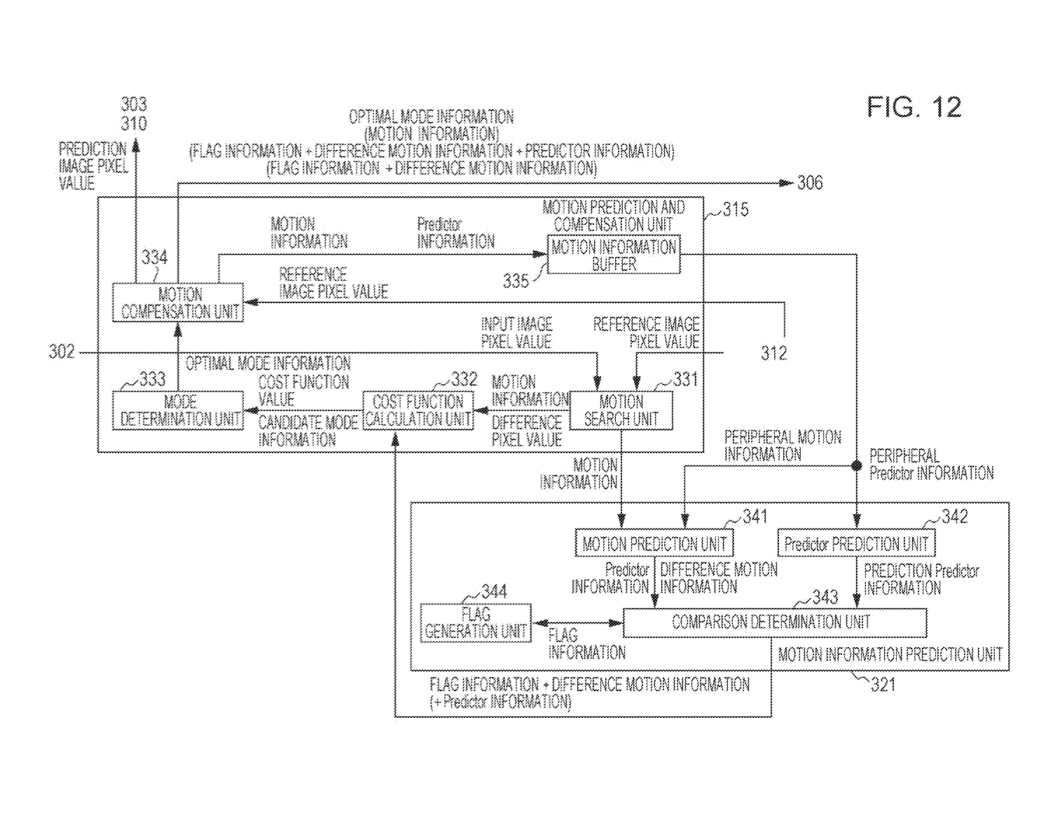

FIG. 12 is a block diagram showing a main configuration example of a motion prediction and compensation unit 315 and a motion information prediction unit 321 of FIG. 11.

As shown in FIG. 12, the motion prediction and compensation unit 315 includes a motion search unit 331, a cost function calculation unit 332, a mode determination unit 333, a motion compensation unit 334 and a motion information buffer 335.

In addition, the motion information prediction unit 321 includes a motion prediction unit 341, a Predictor prediction unit 342, a comparison determination unit 343 and a flag generation unit 344.

The motion search unit 331 performs a process obtaining a motion vector of the current PU from difference of the input image and the reference image. Therefore, the motion search unit 331 acquires an input image pixel value of the current PU which is a processing target from the screen arrangement buffer 302, and acquires a reference image pixel value corresponding to the current PU from the frame memory 312 via the selection unit 313. The motion search unit 331 obtains the difference (difference pixel value) of the input image pixel value and the reference image pixel value, performs a motion search using the difference pixel value and obtains a motion vector of the current PU.

The motion search unit 331 generates motion information including a motion vector of the current PU obtained in this way. Arbitrary information relating to the size or the like of the current PU, or motion prediction of the current PU, in addition to the motion vector of the current PU, is included in the motion vector.

The motion search unit 331 provides the motion information and difference pixel value to the cost function calculation unit 332. The motion search unit 331 performs such processing using a plurality of modes.

In the case of this method, when decoding the encoded data, there is a need for the motion vector of the current PU. That is, there is a need for the prediction process of the motion search unit 331 to encode motion vectors only for the number of PUs employed, and since the encoding rate increases by the same amount, there is concern of the encoding efficiency reducing.

In contrast, the motion prediction unit 341 of the motion information prediction unit 321 performs a process predicting the motion vector of the current PU using the motion vector of the peripheral PU. In the case of this method, in the decoding side, since it is possible to predict the motion vector of the current PU from the peripheral PU in the same manner, there is no need for encoding the motion vector, and the encoding efficiency is able to be improved by the same amount.

The motion prediction unit 341 acquires motion information (peripheral motion information) of a PU processed in the past from the motion information buffer 335.

The PU of the peripheral motion information may be any PU if the motion information thereof is stored in the motion information buffer 335 by being processed in the past. However, ordinarily, the closer a PU is in distance or time to the current PU, the higher the correlation to the current PU. Accordingly, it is desirable that the motion prediction unit 341 acquire motion information of a PU positioned in the vicinity of the current PU or of a PU adjacent to the current PU (peripheral PU) as peripheral motion information.

Moreover, the motion prediction unit 341 is able to acquire motion information of an arbitrary number of PUs as the peripheral motion information. Arbitrary information relating to the motion vector or size and the like of the PU and the motion prediction of the PU is included in each item of peripheral motion information.

The motion prediction unit 341 predicts the motion vector of the current PU (prediction motion vector) using the acquired peripheral motion information. The motion search unit 341 performs such processing using a plurality of modes. It is possible to perform prediction using an arbitrary mode other than only the modes stipulated in the AVC encoding method or the modes proposed in the above-described citations.

That is, the motion prediction unit 341 includes a plurality of predictors (predictor (Predictor)) predicting the motion vector using mutually different methods, and predicts the motion vector of the current PU using each Predictor.

In addition, the motion prediction unit 341 acquires motion information from the motion search unit 331. The motion prediction unit 341 obtains the difference with the motion vector of the current PU obtained by the motion search unit 331 for each of the prediction motion vectors of the current PU predicted using each Predictor, and selects the prediction vector with the smallest difference as the optimal prediction result.

The motion prediction unit 341 provides the difference motion information including a difference corresponding to the prediction motion vector selected as the optimal prediction result and Predictor information indicating a Predictor used in generation of the prediction motion vector selected as the optimal prediction result to the comparison determination unit 343.

In the case of this method, when decoding the encoded data, there is a need for Predictor information indicating which Predictor is used to predict the motion vector of the current PU during encoding. That is, there is a need for the prediction process of the motion search unit 341 to encode Predictor information only for the number of PUs employed, and since the encoding rate increases by the same amount, there is concern of the encoding efficiency reducing.

In contrast, the Predictor prediction unit 342 of the motion information prediction unit 321 performs a process predicting the Predictor employed in the current PU using the predictor (Predictor) employed in the peripheral PU. In the case of this method, in the decoding side, since it is possible to predict the Predictor of the current PU from the peripheral PU in the same manner, there is no need for encoding the Predictor information, and the encoding efficiency is able to be improved by the same amount. Moreover, “peripheral” includes both “adjacent to” and “in the vicinity of”. In other words, the peripheral PU includes both an adjacent PU adjacent to the current PU and a neighboring PU positioned in the vicinity of the current PU. In a case indicating a specified PU, either of an adjacent PU and a neighboring PU may be indicated.

The Predictor prediction unit 342 acquires Predictor information (peripheral Predictor information) of a PU processed in the past from the motion information buffer 335.

The PU of the peripheral Predictor information may be any PU if the Predictor information thereof is stored in the motion information buffer 335 by being processed in the past. However, ordinarily, the closer a PU is in distance or time to the current PU, the higher the correlation to the current PU. Accordingly, it is desirable that the motion prediction unit 341 acquire Predictor information of a PU positioned in the vicinity of the current PU (or a PU adjacent to the current PU) as peripheral Predictor information.

Moreover, the Predictor prediction unit 342 is able to acquire Predictor information of an arbitrary number of PUs as the peripheral Predictor information.

The Predictor prediction unit 342 predicts the Predictor of the current PU using the acquired peripheral Predictor information. The specific method of prediction of the Predictor will be described later.

The Predictor prediction unit 342 provides prediction Predictor information indicating the Predictor of the predicted current PU to the comparison determination unit 343.

In the case of the method of the Predictor prediction unit 342, it is possible to improve the encoding efficiency over the basic method of the motion prediction unit 341; however, it is not preferable that the prediction precision of the prediction motion vector be lower than the prediction precision of the motion prediction unit 341.

For example, between the peripheral PU and the current PU, the correlation of the Predictor may also be considered low according to the content of the image. In such a case, there is concern of the prediction precision of the prediction motion vector predicted using the predictor predicted by the Predictor prediction unit 342 being lower than the prediction precision of the prediction motion vector predicted by the motion prediction unit 341.

Here, the comparison determination unit 343 employs prediction Predictor information generated by the Predictor prediction unit 342 only in a case where the Predictor predicted by the Predictor prediction unit 342 matches the Predictor employed in the motion prediction unit 341, and in a case of not matching, employs the prediction result of the motion prediction unit 341.

More specifically, the comparison determination unit 343 compares the Predictor information provided from the motion prediction unit 341 and the prediction Predictor information provided from the Predictor prediction 342, and determines whether or not both Predictors match.

The flag generation unit 344 generates flag information indicating the determination results of the comparison determination unit 343 and provides the information to the comparison determination unit 343.

In a case where the Predictor information and the prediction Predictor information do not match, the comparison determination unit 343 causes the flag generation unit 344 to generate flag information indicating the employment of the Predictor information, and acquires the flag. The comparison determination unit 343 provides the flag information acquired from the flag generation unit 344, difference motion information provided from the motion prediction unit 341 and Predictor information to the cost function calculation unit 332 of the motion prediction and compensation unit 315.

In addition, in a case where the Predictor information and the prediction Predictor information match, the comparison determination unit 343 causes the flag generation unit 344 to generate flag information indicating employment of prediction Predictor information, and acquires the flag. The comparison determination unit 343 provides the flag information acquired from the flag generation unit 344 and the difference motion information provided from the motion prediction unit 341 to the cost function calculation unit 332 of the motion prediction and compensation unit 315. That is, in this case, since method predicting the Predictor using the Predictor prediction unit 342 is employed, provision of the Predictor information (encoding) may be not performed. Accordingly, in this case, the encoding efficiency of the image encoding device 300 may be improved by this amount.

The cost function calculation unit 332 calculates a cost function value of the result of encoding using the prediction result generated in each mode as above. The calculation method of the cost function is arbitrary. For example, the cost function calculation unit 332 calculates the cost function value of each mode using the above-described Expression (15) and Expression (16). The cost function calculation unit 332 provides the calculated cost function value of each mode and candidate mode information which is information relating to each mode including motion information or flag information, or the like, to the mode determination unit 333.

The mode determination unit 333 selects the optimal mode based on the cost function value of each mode provided from the cost function calculation unit 332. The selection method of the optimal mode is arbitrary; however, for example, the mode determination unit 333 selects the mode for which the cost function value is the smallest as the optimal mode. The mode determination unit 333 provides information relating to the optimal mode (for example, motion information or flag information) as optimal mode information to the motion compensation unit 334.

The motion compensation unit 334 generates a prediction image using the mode indicated by the optimal mode information using a reference image pixel value read out from the frame memory 312 via the selection unit 313, and provides this prediction image pixel value to the computation unit 303 and computation unit 310 via the selection unit 316.

The motion compensation unit 334 further provides the optimal mode information to the lossless encoder 306 and encodes the information. The content of the optimal mode information differs according to the selected mode. For example, in the case of a mode using the motion vector obtained by the motion search unit 331, the motion information of the current PU is included in the optimal mode information. In addition, in the case of a mode using the prediction motion vector predicted by the motion prediction unit 341, the flag information of the current PU, difference motion information and Predictor information are included in the optimal mode information. Furthermore, for example, in a case of a mode using the Predictor predicted by the Predictor prediction unit 342, the flag information of the current PU and the difference motion information are included in the optimal mode information.

Furthermore, the motion compensation unit 334 provides motion information of the current PU or Predictor information to the motion information buffer 335 and the information is stored.

The motion information buffer 335 stores motion information of the current PU provided from the motion compensation unit 334 and Predictor information. The motion information buffer 335 provides this information as peripheral motion information or peripheral Predictor in the process with respect to another PU different from the current PU to the motion prediction unit 341 or the Predictor prediction unit 342 at a predetermined timing or based on a request from outside, such as the motion prediction unit 341 or the Predictor prediction unit 342.

### [Prediction of Predictor]

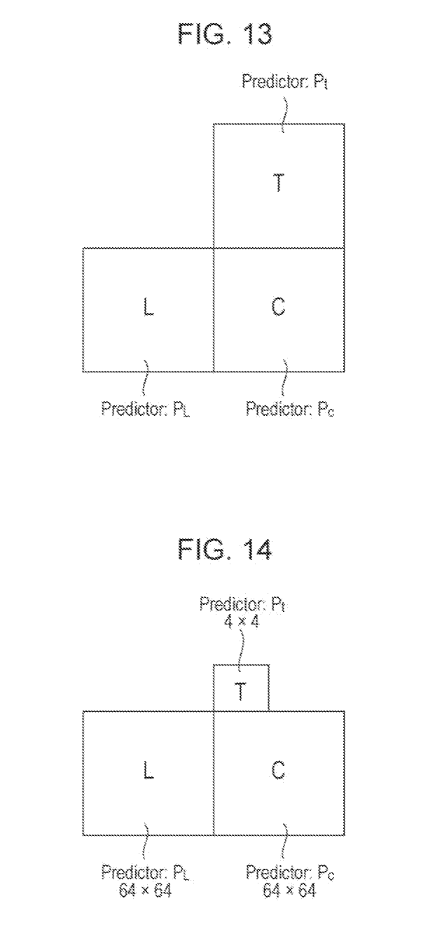

FIG. 13 is a diagram describing the prediction method of the Predictor by the Predictor prediction unit 342. In FIG. 13, C is the current PU, T and L are PUs (peripheral PU) adjacent to the upper portion and the left portion of the current PU (C). The Predictor used in prediction of the prediction motion vector in the current PU (C) is set to pc. In addition, the Predictor using in prediction of the prediction motion vector in the peripheral PU (T) is set to pr. Furthermore, the Predictor using in prediction of the prediction motion vector in the peripheral PU (L) is set to p_{L}.

The Predictor prediction unit 342 predicts p_{C} from p_{T} and p_{L}. The comparison determination unit 343, only in a case in which the predicted value (predp_{C}) of p_{C} and the actual value of p_{C} obtained by the motion prediction unit 341, causes the values of the p_{C} to be encoded (added to encoded data output by the image encoding device 300).

Moreover, the peripheral PU used in prediction of the Predictor is not limited thereto, and may be another adjacent PU, such as the upper left portion and upper right portion. In addition, prediction of the Predictor of the current PU may be performed using the predictor information of a PU adjacent in the time direction so as to be co-located.

For example, the Predictor prediction unit 342 calculates the prediction value predp_{C} of p_{C} from p_{T} and p_{L} as in the following Expression (20).

predp_{C}=min(p_{T}, p_{L}) (20)

In a case where the predpe and the value of p_{C} are equal to each other, flag information (flag) indicating this fact is generated by the flag generation unit 344, and encoded (added to the encoded data output by the image encoding device 300). In this case, the actual value of p_{C} is not encoded (not added to the encoded data output by the image encoding device 300).

In a case where the predp_{C} and the value of p_{C} are not equal to each other, flag information (flag) indicating this fact is generated by the flag generation unit 344, and encoded (added to the encoded data output by the image encoding device 300). In this case, the actual value of p_{C} (or, the difference value of p_{C} and predp_{C}) is also encoded (added to the encoded data output by the image encoding device 300).

Moreover, in a case where the peripheral PU is intra encoded, the Predictor prediction unit 342 performs processing with respect to the Predictor with the code number set as “0”.

In addition, in a case where the peripheral PU (L) is not present for the reason of being at, for example, the image edge or slice boundary, or the like, the Predictor prediction unit 342 calculates the prediction value predp_{C} using p_{T} as in the following Expression (21).

predp_{C}=p_{T} (21)

Conversely, in a case where a peripheral PU(T) is not present, the Predictor prediction unit 342 calculates the prediction value predp_{C} using p_{L} as in the following Expression (22).

predp_{C}=p_{L} (22)

In a case where none of the peripheral PUs are present, the Predictor prediction unit 342 does not perform prediction of the Predictor. In this case, the comparison determination unit 343 employs the prediction result of the motion prediction unit 341. That is, the above-described Predictor information and prediction Predictor information are processed in the same manner as a case of a mismatch.

Ordinarily, there is a correlation between the current PU and a peripheral PU in the motion information; accordingly, the Predictor may also be considered as having a correlation. The Predictor prediction unit 342 is able to realize an improvement in encoding efficiency of the motion vector information based on the motion vector competition process proposed in, for example, NPL 1 by performing an encoding process using the correlation of the Predictor.

Moreover, the size relationship of the PUs may be used in determining the magnitude of the correlation between the current PU and the peripheral PU. Ordinarily, in a case where the correlation of the motion information between, for example, two given PUs is high, the possibility of the correlation of the size of the two PUs also increasing is high. For example, in a case of an image with a lot of motion, the possibility of the change in texture becoming severs is high, and the size of the PU may be easily set to be small. In contrast, in the case of an image with little motion, for example, as in a background of the sky or the like, the possibility of a simple texture spreading widely is high, and the size of the PU may easily be set large.

In other words, in a case where the size of the PUs differ greatly from each other, such as a moving object and a still object, the possibility of the characteristics of the images differing greatly is high, and between such PUs, the possibility of the correlation of the motion vector or Predictor being low is high.

The Predictor prediction unit 342 may estimate the correlation of the motion vector or Predictor between PUs from the relationship of the size of the PUs using such characteristics.

For example, as shown in FIG. 14, the size of the current PU (C) is 64×64, the size of the peripheral PU (L) is 64×64, and the size of the peripheral PU (T) is 4×4. In such a case, the Predictor prediction unit 342 is correlated between the current PU (C) and the peripheral PU (L); however, the correlation with peripheral PU (T) is considered to be low.

That is, for example, the size of the current PU (C) may be set to be N×N. In this case, the Predictor prediction unit 342, in a case where the size of the peripheral PU (L) and the peripheral PU (T) is 2N×2N, N×N, or N/2×N/2, calculates predpe using the above-described Expression (20).

In addition, in a case where the size of the peripheral PU (T) is 2N×2N, N×N, or N/2×N/2; but the peripheral PU (L) has another size, the Predictor prediction unit 342 calculates predpc using the above-described Expression (21).

Furthermore, in a case where the size of the peripheral PU (L) is 2N×2N, N×N, or N/2×N/2; but the peripheral PU (T) has another size, the Predictor prediction unit 342 calculates predp: using the above-described Expression (22).

In addition, in a case where the peripheral PU (L) and the peripheral PU (T) have a size other than 2N×2N, N×N, or N/2×N/2, the Predictor prediction unit 342 may not perform prediction of the Predictor.

Moreover, there is a possibility of the encoding process being performed on the peripheral PU (L) and peripheral PU (T) using the MergeFlag proposed in NPL 3. In this case, in a case where the motion information of the peripheral PU (T) is merged using the MergeFlag, an index signifying the motion information of the peripheral PU (T) may be used as p_{T} and p_{L}. In contrast, in a case where the motion information of the peripheral PU (L) is merged using the MergeFlag, an index signifying the motion information of the peripheral PU (L) may be used as pT and pL.

### [Flow of Encoding Process]

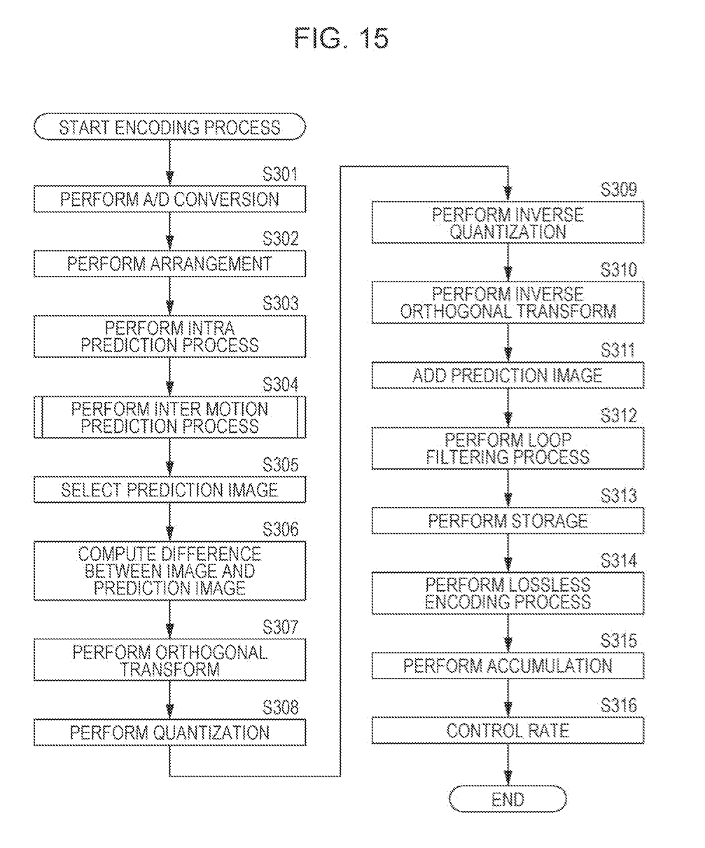

Next, the flow of each process executed by the image encoding device 300 as described above will be described. First, an example of the flow of the encoding process will be described with reference to the flowchart in FIG. 15.

In Step S301, the A/D converter 301 performs A/D conversion on the input image. In Step S302, the screen arrangement buffer 302 stores the A/D converted image and performs arrangement thereon from the display order of each picture to an encoding order.

In Step S303, the intra prediction unit 314 performs an intra prediction process of the intra prediction mode. In Step S304, the motion prediction and compensation unit 315 performs an inter motion prediction process performing motion prediction or motion compensation in the inter prediction mode.

In Step S305, the selection unit 316 determines the optimal mode based on each cost function value output from the intra prediction unit 314 and motion prediction and compensation unit 315. That is, the selection unit 316, selects any one of the prediction image generated by the intra prediction unit 314 and the prediction image generated by the motion prediction and compensation unit 315.

In addition, selection information indicating whichever prediction image is selected is provided to the one of the intra prediction unit 314 and the motion prediction and compensation unit 315 which selected the prediction image. In a case where the prediction image of the optimal intra prediction mode is selected, the intra prediction unit 314 provides intra prediction mode information indicating the optimal intra prediction mode or the like to the lossless encoder 306. In a case where the prediction image of the optimal inter prediction mode is selected, the motion prediction and compensation unit 315 provides information indicating the optimal inter prediction mode and, as needed, information according to the optimal inter prediction mode to the lossless encoder 306.

In Step S306, the computation unit 303 computes the difference between the image arranged by the process in Step S302 and the prediction image selected by the process in Step S305. The prediction image is provided to the computation unit 303 via the selection unit 316, from the motion prediction and compensation unit 315 in the case of inter prediction, and from the intra prediction unit 314 in the case of intra prediction.

The difference data has a reduced amount of data compared to the original image data. Accordingly, compared to a case of encoding an image as is, it is possible to compress the amount of data.

In Step S307, the orthogonal transform unit 304 performs an orthogonal transform on the difference information generated by the process in Step S306. Specifically, an orthogonal transform, such as discrete cosine conversion or Karhunen-Loeve Transform, is performed and the transform coefficient is output.

In Step S308, the quantization unit 305 performs quantization on the orthogonal transform coefficient obtained by the process in Step S307.

The difference information quantized by the process in Step S308, is locally decoded as next. That is, in Step S309, the inverse quantization unit 308 performs inverse quantization on the quantized orthogonal transform coefficient (also referred to as quantization coefficient) generated by the process in Step S308 using characteristics corresponding to characteristics of the quantization unit 305. In Step S310, inverse orthogonal transform unit 309 performs an inverse orthogonal transform corresponding to the characteristics of the orthogonal transform unit 304 on the orthogonal transform coefficient obtained by the process in Step S307.

In Step S311, the computation unit 310 adds the prediction image to the locally decoded difference information and generates a locally decoded image (image corresponding to the input to the computation unit 303). The loop filter 311 in Step S312 appropriately performs a loop filtering process including a deblocking filter process or an adaptive loop filtering process, or the like, with respect to the local decoded image obtained by the process in Step S311.

In Step S313, the frame memory 312 stored the decoded image subjected to the loop filtering process by the process in Step S312. Moreover, an image not subjected to a filtering process by the loop filter 311 is also provided from the computation unit 310, and stored in the frame memory 312.

In Step S314, the lossless encoder 306 encodes the transform coefficient quantized by the process in Step S308. That is, lossless encoding, such as variable length encoding or arithmetic coding, is performed with respect to the difference image.

Moreover, the lossless encoder 306 encodes the quantization parameter calculated in Step S308, and adds the encoded data. In addition, the lossless encoder 306 encodes information relating to the mode of the prediction image selected by the process in Step S305 and adds the encoded data obtained by encoding the difference image. That is, the lossless encoder 306 also encodes information, or the like, according to the optimal intra prediction mode information provided from the intra prediction unit 314 or the optimal inter prediction mode provided from the motion prediction and compensation unit 315, and adds the encoded data.

The storage buffer 307 in Step S315 stores the encoded data output from the lossless encoder 306. The encoded data stored in the storage buffer 307 is appropriately read out, and transmitted to the decoding side via a transmission path or recording medium.

The rate controller 317 in Step S316 controls the rate of the quantization operation of the quantization unit 305 based on the encoding rate (generated encoding rate) of the encoded data stored in the storage buffer 307 by the process in Step S315 such that an overflow or an underflow does not occur.

When the process in Step S316 finishes, the encoding process is finished.

### [Flow of Inter Motion Prediction Process]

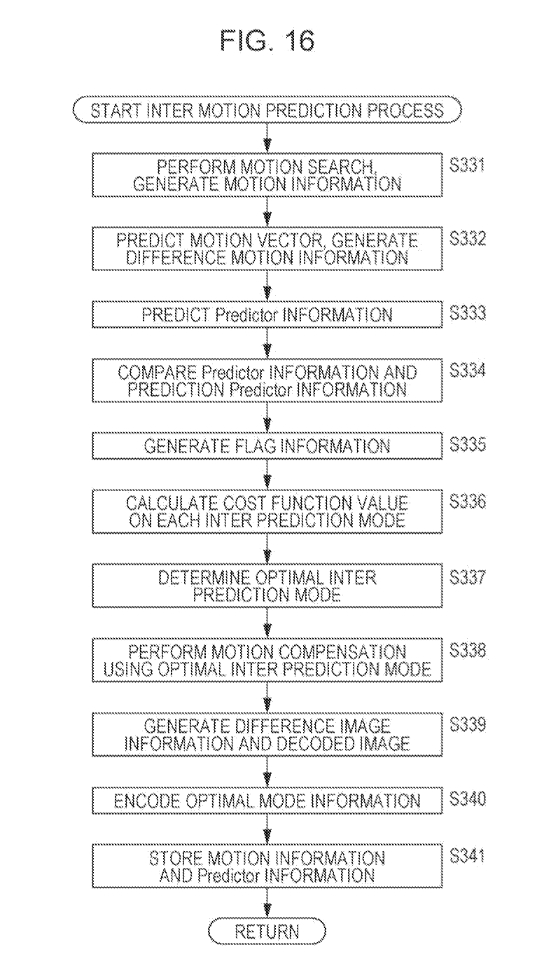

Next, the flow of the inter motion prediction process executed in Step S304 in FIG. 15 will be explained referring to the flowchart in FIG. 16.

When the inter motion prediction process is started, the motion search unit 331, in Step S331, performs a motion search and generates motion information.

In Step S332, the motion prediction unit 341 predicts the motion vector of the current PU using the peripheral motion information, obtains the difference with the motion vector of the motion search results, obtains optimal prediction results using this difference, and generates difference motion information using the optimal prediction results. In addition, the motion prediction unit 341 generates Predictor information indicating the Predictor used to obtain the optimal prediction result.

In Step S333, the Predictor prediction unit 342 predicts the Predictor of the current PU (obtains a prediction Predictor) using the peripheral Predictor information.

In the Step S334, the comparison determination unit 343 compares the Predictor information generated in Step S332 and the prediction Predictor information predicted in Step S333, and determines whether or not both match.

In Step S335, the flag generation unit 344 generates flag information indicating the comparison determination results of Step S332.

In Step S336, the cost function calculation unit 332 calculates the cost function value of the encoding results with respect to each inter prediction mode. In Step S337, the mode determination 333 determines the optimal inter prediction mode based on the cost function value calculated in Step S336.

In Step S338, the motion compensation unit 334 performs motion compensation using the optimal inter prediction mode determined in Step S337 using the reference image acquired from the frame memory 312.

In Step S339, the motion compensation unit 334 generates difference image information by providing a prediction image pixel value generated by the motion compensation process in Step S338 to the computation unit 303 via the selection unit 316, and generates a decoded image by providing this information to the computation unit 310.

In Step S340, motion compensation unit 334 provides optimal mode information generated by the motion compensation process in Step S338 to the lossless encoder 306, and encodes the information.

In Step S341, the motion information buffer 335 acquires motion information or Predictor information used by the motion compensation process in Step S338, and stores this. These items of information are used as information of the peripheral PU in an encoding process with respect to other PUs performed chronologically thereafter.

When the process of Step S341 finishes, the motion information buffer 335 finishes the inter motion prediction process and returns the process to Step S304 in FIG. 15, and the processes subsequent to Step S305 are executed.

As above, by executing each process, the image encoding device 300, in inter prediction, predicts the Predictor of the current PU through the Predictor of the peripheral PU, and is able to perform motion prediction using this prediction Predictor. By using such a prediction Predictor, in a case of predicting the motion vector of the current PU based on the motion information of the peripheral PU, it is possible to not perform encoding of the Predictor information, and the image encoding device 300 is able to improve the encoding efficiency.

### 2. Second Embodiment

### Image Decoding Device

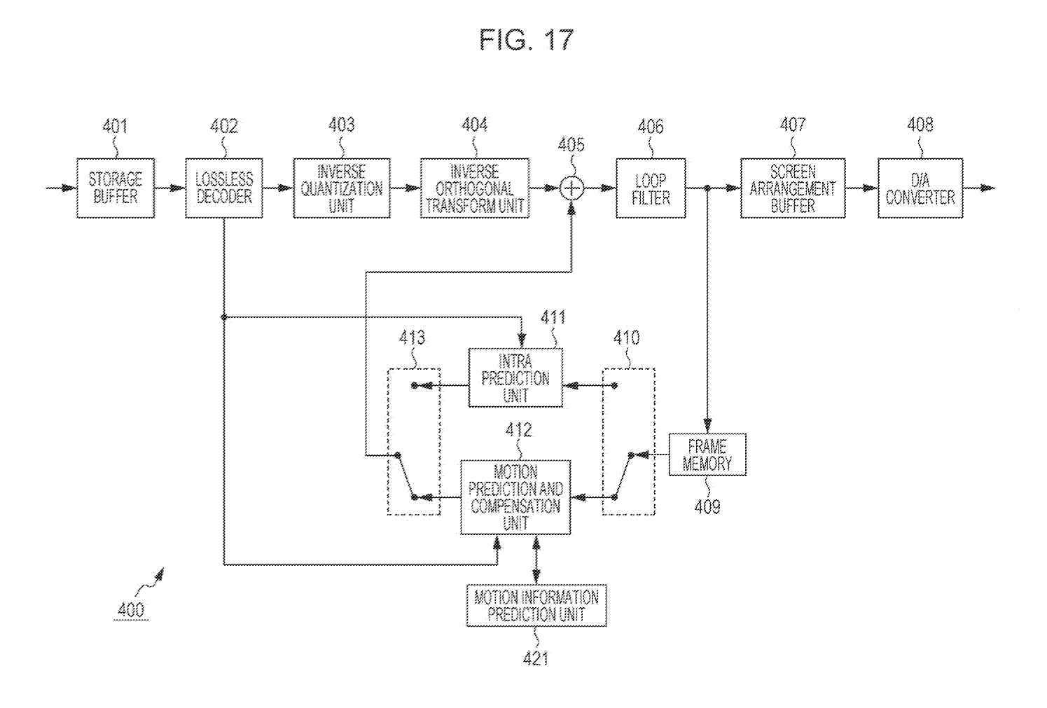

FIG. 17 is a block diagram showing a main configuration example of an image encoding device. The image decoding device 400 shown in FIG. 17 is a decoding device corresponding to the image encoding device 300 of FIG. 11. The encoding data encoded by the image encoding device 300 is provided to the image decoding device 400 via an arbitrary route, such as, for example, a transmission path or recording medium, and is decoded.

As shown in FIG. 17, the image decoding device 400 includes a storage buffer 401, a lossless decoder 402, an inverse quantization unit 403, an inverse orthogonal transform unit 404, a computation unit 405, a loop filter 406, and screen arrangement buffer 407 and a D/A converter 408. In addition, the image decoding device 400 includes a frame memory 409, a selection unit 410, an intra prediction unit 411, a motion prediction and compensation unit 412 and a selection unit 413.

The image decoding device 400 further includes a motion information prediction unit 421.

The storage buffer 401 stores encoded data transmitted thereto. The encoded data is encoded by the image encoding device 300. The lossless decoder 402 reads out the encoded data from the storage buffer 401 at a predetermined timing, and decodes the data with a method corresponding to the encoding method of the lossless encoder 306 in FIG. 11.

In addition, in a case where the current frame is intra encoded, intra prediction mode information is accommodated in the header portion of the encoded data. The lossless decoder 402 also decodes the intra prediction mode information and provides the information to the intra prediction unit 411. In contrast, in a case where the frames are intra encoded, motion vector information or inter prediction mode information is accommodated in the header portion of the encoded data. The lossless encoder 402 also decodes this motion vector information or inter prediction mode information, and provides this information to the motion prediction and compensation unit 412.

The inverse quantization unit 403 performs inverse quantization of coefficient data (quantized coefficient) obtained by decoding by the lossless decoder 402 using a method corresponding to the quantization method of the quantization unit 305 of FIG. 11. In other words, the inverse quantization unit 403 performs inverse quantization of the quantization coefficient using a similar method to the inverse quantization unit 308 of FIG. 11.

The inverse quantization unit 403 provides coefficient data subjected to inverse quantization, that is, orthogonal transform coefficient, to the inverse orthogonal transform unit 404. The inverse orthogonal transform unit 404 performs an inverse orthogonal transform on this orthogonal transform coefficient using a method corresponding to the orthogonal transform method (similar method to the inverse orthogonal transform unit 309 in FIG. 11) of the orthogonal transform unit 304 in FIG. 11. The inverse orthogonal transform unit 404 obtains decoded residual data corresponding to residual data before the orthogonal transform is performed in the image encoding device 300 through the inverse orthogonal transform process. For example, a fourth order inverse orthogonal transform is performed.

The decoded residual data obtained by performing the inverse orthogonal transform is provided to the computation unit 405. In addition, in the computation unit 405, a prediction image is provided from the intra prediction unit 411 or the motion prediction and compensation unit 412 via the selection unit 413.

The computation unit 405 adds the decoded residual data and the prediction image, and obtains the decoded image data corresponding to image data before the prediction image is subtracted by the computation unit 303 of the image encoding unit 300. The computation unit 405 provides the decoded image data to the deblocking filter 406.

The loop filter 406 appropriately performs a loop filtering process including a deblock filtering process or adaptive loop filtering process with respect to the decoded image provided, and provides this to the screen arrangement buffer 407.

The loop filter 406 performs an appropriate filtering process with respect to the decoded image provided from the computation unit 405, including deblock filtering or adaptive loop filtering, or the like. For example, the loop filter 406 removes the blocking effects of the decoded image by performing a deblock filtering process with respect to the decoded image. In addition, for example, the loop filter 406 performs image quality improvement by performing a loop filtering process using a Weiner filter (Weiner Filter) with respect to the deblock filtering process results (decoded image on which blocking effect removal is performed).

Moreover, the loop filter 406 may perform an arbitrary filtering process with respect to the decoded image. In addition, the loop filter 406 may perform a filtering process using a filter coefficient provided from the image encoding device 300 in FIG. 11.

The loop filter 406 provides the filter processing results (decoded image after the filtering process) to the screen arrangement buffer 407 and frame memory 409. Moreover, the decoded image output from the computation unit 405 may be provided to the screen arrangement buffer 407 or frame memory 409 without passing through the loop filter 406. In other words, it is possible to not perform the filtering process using the loop filter 406.

The screen arrangement buffer 407 performs arrangement of the image. In other words, the order of the frames arranged for the encoding order by the screen arrangement buffer 302 of FIG. 11 is arranged in the original display order. The D/A converter 408 performs D/A conversion on the image provided from the screen arrangement buffer 407, and outputs and displays the image on a display not shown in the diagrams.

The frame memory 409 stores the provided decoded image and provides the stored decoded image at a predetermined timing or based on a request from outside, such as intra prediction unit 411 or motion prediction and compensation unit 412, or the like, to the selection unit 410 as a reference image.

The selection unit 410 selects the provision destination of the reference image provided from the frame memory 409. The selection unit 410, in the case of decoding the intra encoded image, provides the reference image provided from the frame memory 409 to the intra prediction unit 411. In addition, the selection unit 410, in the case of decoding the inter encoded image, provides the reference image provided from the frame memory 409 to the motion prediction and compensation unit 412.

In the intra prediction unit 411, information or the like indicating the intra prediction mode obtained by decoding header information is appropriately provided from the lossless decoder 402. The intra prediction unit 411, in the intra prediction mode used in the intra prediction unit 314, performs intra prediction using the reference image acquired from the frame memory 409, and generates a prediction image. That is, the intra prediction unit 411, similar to the intra prediction unit 314, is able to perform the intra prediction using an arbitrary mode other than the mode stipulated in the AVC encoding method.

The intra prediction unit 411 provides the prediction image generated to the selection unit 413.

The motion prediction and compensation unit 412 acquires information (such as prediction mode information, motion vector information, reference frame information, flags and various parameters) obtained by decoding header information from the lossless decoder 402.

The motion prediction and compensation unit 412, using the inter prediction mode used in the motion prediction and compensation unit 315, performs inter prediction using the reference image acquired from the frame memory 409, and generates a prediction image. That is, the motion prediction and compensation unit 412, similar to the motion prediction and compensation unit 315, is able to perform the intra prediction using an arbitrary mode other than the mode stipulated in the AVC encoding method.

The motion prediction and compensation unit 412, similarly to the case of the motion prediction and compensation unit 212, provides the generated prediction image to the selection unit 413.

The selection unit 413 selects the provision destination of the prediction image provided to the computation unit 405. That is, the selection unit 413 provides the prediction image generated by the motion prediction and compensation unit 412 or the intra prediction unit 411 to the computation unit 405.

The motion information prediction unit 421 generates prediction motion information used in the process of the motion prediction and compensation unit 412.

### [Motion Prediction and Compensation Unit and Motion Information Prediction Unit]

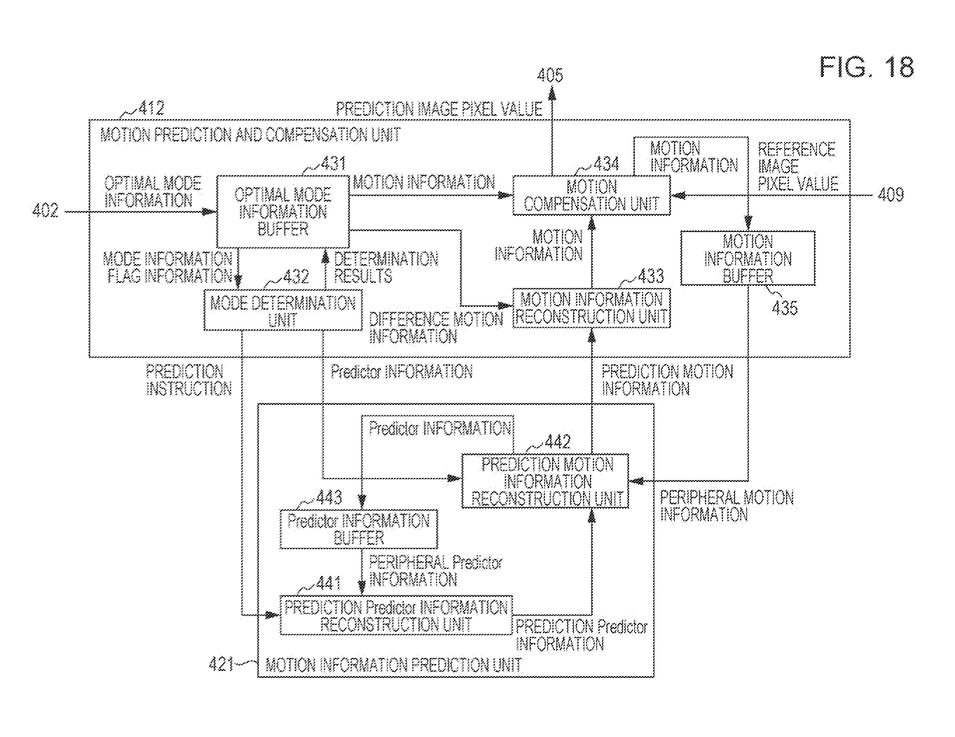

FIG. 18 is a block diagram showing a main configuration example of a motion prediction and compensation unit 412 and a motion information prediction unit 421 of FIG. 17.

As shown in FIG. 18, the motion prediction and compensation unit 412 includes an optimal mode information buffer 431, a mode determination unit 432, a motion information reconstruction unit 433, a motion compensation unit 434, and a motion information buffer 435.

In addition, as shown in FIG. 18, the motion prediction and compensation unit 421 includes a prediction Predictor information reconstruction unit 441, a prediction motion information reconstruction unit 442, and a Predictor information buffer 443.

The optimal mode information buffer 431 of the motion prediction and compensation unit 412, in the case of inter encoding, acquires optimal mode information extracted from the encoded data in the lossless decoder 402, and stores the information. The optimal mode information buffer 431 provides mode information indicating the inter prediction mode employed in the image encoding device 300, flag information relating to the prediction of the predictor (Predictor) described referring to FIG. 12 and Predictor information, or the like, of the current PU included in the optimal mode information of the current PU, to the mode determination unit 432 at a predetermined timing or based on a request from outside, such as the mode determination unit 432, for example.

The mode determination unit 432 determines the inter prediction mode employed in the image encoding device 300 based on these information items.

In the image encoding device 300, in the case where the mode determined by the motion vector from the difference between the input image and the reference image is determined to be employed, the mode determination unit 432 provides the determination result to the optimal mode information buffer 431.

The optimal mode information buffer 431 provides the motion information of the current PU included in the optimal mode information to the motion compensation unit 434 based on the determination results.

The motion compensation unit 434 acquires motion information of the current PU provided from the image encoding device 300 from the optimal mode information buffer 431 and acquires the reference image corresponding to this motion information from the frame memory 409 via the selection unit 410. The motion compensation unit 434 generates the prediction image using the reference image pixel value read out from the frame memory 409, and provides this prediction image pixel value to the computation unit 405 via the selection unit 413.

In addition, the motion compensation unit 434 provides motion information of the current PU used in the motion compensation to the motion information buffer 435 and stores the information. The motion information stored in the motion information buffer 435 is used as motion information of a peripheral PU positioned at the periphery of the current PU (peripheral motion information) in the processing of other PUs processed chronologically thereafter. Moreover, “peripheral” includes both “adjacent to” and “in the vicinity of”. In other words, the peripheral PU includes both an adjacent PU adjacent to the current PU and a neighboring PU positioned in the vicinity of the current PU.

In a case indicating a specified PU, either of an adjacent PU and a neighboring PU may be indicated.

In addition, in the image encoding device 300, in the case where the mode predicting the motion vector of the current PU from the motion vector of the peripheral PU is determined to be employed, the mode determination unit 432 provides the Predictor information of the current PU to the prediction motion information reconstruction unit 442 of the motion information prediction unit 421 along with providing the determination results to the optimal mode information buffer 431.

The prediction motion information reconstruction unit 442 acquires the Predictor information of the current PU and acquires motion information of the peripheral PU (peripheral motion information) processed in the past from the motion information buffer 435 of the motion prediction and compensation unit 412. The prediction motion information reconstruction unit 442 predicts the motion information of the current PU (reconstructs the prediction motion information) from the peripheral motion information using the predictor (predictor (Predictor)) indicated by the Predictor information of the current PU. The prediction motion information reconstruction unit 442 provides the reconstructed prediction motion information to the motion information reconstruction unit 433 of the motion prediction and compensation unit 412.

The optimal mode information buffer 431 which acquired the determination results from the mode determination unit 432 provides difference motion information of the current PU included in the optimal mode information of the current PU to the motion information reconstruction unit 433. The motion information reconstruction unit 433 acquires prediction motion information from the prediction motion information reconstruction unit 442, acquires difference motion information from the optimal mode information buffer 431, adds the motion prediction information to the difference motion information, and reconstructs the motion information of the current PU. The motion information reconstruction unit 433 provides motion information of the reconstructed PU to the motion compensation unit 434.

The motion compensation unit 434, similarly to the above-described case, reads out the reference image corresponding to the motion information of the current PU provided from the motion information reconstruction unit 433 from the frame memory 409, generates the prediction image, and provides this prediction image pixel value to the computation unit 405 via the selection unit 413.

In addition, the motion compensation unit 434, similarly to the above-described case, provides motion information of the current PU used in the motion compensation to the motion information buffer 435 and stores the information. Furthermore, the prediction motion information reconstruction unit 442 provides the Predictor information of the current PU to the Predictor information buffer 443, and the information is stored. The Predictor information stored in the Predictor information buffer 443 is used as Predictor information of a peripheral PU (peripheral Predictor information) in the processing of other PUs processed chronologically thereafter.

Furthermore, in the image encoding device 300, in the case where the mode predicting the Predictor of the current PU from the Predictor of the peripheral PU is determined to be employed, the mode determination unit 432 provides a prediction instruction instructing the reconstruction of the prediction Predictor information to the prediction Predictor information reconstruction unit 441 of the motion information prediction unit 421 along with providing the determination results to the optimal mode information buffer 431.

The prediction Predictor information reconstruction unit 441 performs reconstruction of the Predictor prediction information following the prediction instruction. The prediction Predictor information reconstruction unit 441 acquires the Predictor information of the peripheral PU (peripheral Predictor information) from the Predictor information buffer 443, and predicts (reconstructs the prediction Predictor information) the Predictor of the current PU (predp_{C}) using the peripheral Predictor information with the same method as the Predictor prediction unit 342 described referring to FIG. 13 and FIG. 14.

The prediction Predictor information reconstruction unit 441 provides reconstructed prediction Predictor information to the prediction motion information reconstruction unit 442.

The prediction motion information reconstruction unit 442 acquires peripheral motion information from the motion information buffer 435 using, similarly to the above-described case, using the Predictor indicating the prediction Predictor information, and predicts the motion information of the current PU from the peripheral motion information (reconstructs the prediction motion information). The prediction motion information reconstruction unit 442 provides the reconstructed prediction motion information to the motion information reconstruction unit 433.

Similarly to the above-described case, the optimal mode information buffer 431 provides the difference motion information of the current PU to the motion information reconstruction unit 433. The motion information reconstruction unit 433, similarly to the above-described case, reconstructs the motion information of the current PU by adding the prediction motion information to the difference motion information. The motion information reconstruction unit 433 provides motion information of the reconstructed PU to the motion compensation unit 434.

The motion compensation unit 434, similarly to the above-described case, reads out the reference image corresponding to the motion information of the current PU provided from the motion information reconstruction unit 433 from the frame memory 409, generates the prediction image, and provides this prediction image pixel value to the computation unit 405 via the selection unit 413.

In addition, the motion compensation unit 434, similarly to the above-described case, provides motion information of the current PU used in the motion compensation to the motion information buffer 435 and stores the information. Furthermore, the prediction motion information reconstruction unit 442, similarly to the above-described case, provides the Predictor information of the current PU to the Predictor information buffer 443, and the information is stored.

As above, the motion prediction and compensation unit 412 and the motion information prediction unit 421, based on information provided from the image encoding device 300, appropriately performs motion prediction and motion compensation by reconstructing the prediction Predictor information, reconstructing prediction motion information, or reconstructing the motion information and is able to generate the inter encoding prediction image. Accordingly, the image decoding device 400 is able to appropriately decode the encoding data obtained by the image encoding device 300. In other words, the image decoding device 400 is able to realize an improvement in the encoding efficiency of the encoded data output from the image encoding device 300.

### [Flow of Decoding Process]

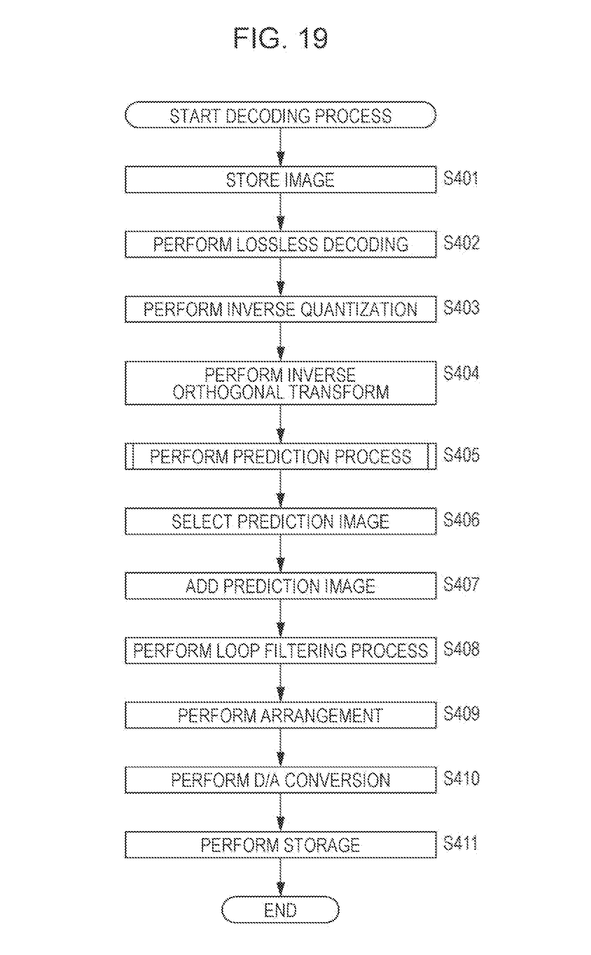

Next, the flow of each process executed by the image decoding device 400 as described above will be described. First, an example of the flow of the decoding process will be described with reference to the flowchart in FIG. 19.

When the decoding process is started, in Step S401, the storage buffer 401 stores the encoded data transmitted thereto. In Step S402, the lossless decoder 402 decodes encoded data (encoded data provided by image data being encoded by the image encoding device 300) provided from the storage buffer 401.

In Step S403, the inverse quantization unit 403 performs inverse quantization of quantized orthogonal transform coefficient obtained by decoding by the lossless decoder 402 using a method corresponding to the quantization process of the quantization unit 305 of FIG. 11. The inverse orthogonal transform unit 404 in Step S404 performs an inverse orthogonal transform on the orthogonal transform coefficient obtained by inverse quantization by the inverse quantization unit 403 using a method corresponding to the orthogonal transform process of the orthogonal transform unit 304 of FIG. 11. In so doing, the difference information corresponding to the input (output of the computation unit 303) of the orthogonal transform unit 304 in FIG. 11 is decoded.

In Step S405, the intra prediction unit 411 and the motion prediction and compensation unit 412 perform a prediction process, and generates a prediction image.

In Step S406, the selection unit 413 selects a prediction image generated by the process in Step S405. In other words, in the selection unit 413, the prediction image generated by the intra prediction unit 411 or the prediction image generated by the motion prediction and compensation unit 412 are provided. The selection unit 413 selects the side to which the prediction image is provided and provides the prediction image to the computation unit 405.

In Step S407, the computation unit 405 adds the prediction image selected in Step S406 to the difference information obtained by the process in Step S404. In so doing, the original image data is decoded.

In Step S408, the loop filter 406 performs appropriate filtering of the decoded image obtained by the process in Step S407.

In Step S409, the screen arrangement buffer 407 performs arrangement of the frames of the decoded image appropriately filtered in Step S408. In other words, the order of the frames arranged for encoding by the screen arrangement buffer 302 (FIG. 11) of the image encoding device 300 is arranged to the original display order.

In Step S410, the D/A converter 408 performs D/A conversion on the decoded image for which the frames are arranged in Step S409. The decoded image data is output to a display not shown in the diagrams, and the image is displayed.

In Step S411, the frame memory 409 stores the decoded image appropriately filtered in Step S408.

When the process of Step S411 finishes, the frame memory 409 finishes the decoding process.

### [Flow of Prediction Process]

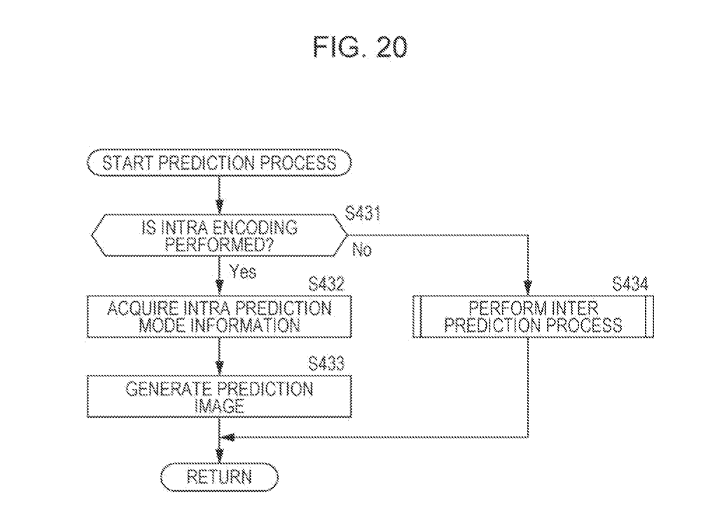

Next, the flow of the prediction process executed in Step S405 in FIG. 19 will be explained referring to the flowchart in FIG. 20.

When the prediction process is started, in Step S431, the lossless decoder 402 determines whether the current PU is intra encoded or not. In a case where it is determined that the current PU is intra encoded, the processing of the lossless encoder 402 progresses to Step S432.

In Step S432, the intra prediction unit 411 acquires intra prediction mode information from the lossless decoder 402. In Step S433, the intra prediction unit 411 performs intra prediction and generates a prediction image. When the process of Step S433 finishes, the intra prediction unit 411 finishes the prediction process, the process returns to Step S405 in FIG. 19, and the processes subsequent to Step S406 are executed.

In addition, in the Step S431 in FIG. 20, in the case where inter encoding is determined, the processing of lossless decoder 402 progresses to Step S434. In Step S434, the motion prediction and compensation unit 412 performs an inter prediction process, and generates a prediction image using the inter prediction. When the process of Step S434 finishes, the motion prediction and compensation unit 412 finishes the prediction process, the process returns to Step S405 in FIG. 19, and the processes subsequent to Step S406 are executed.

### [Flow of Inter Prediction Process]

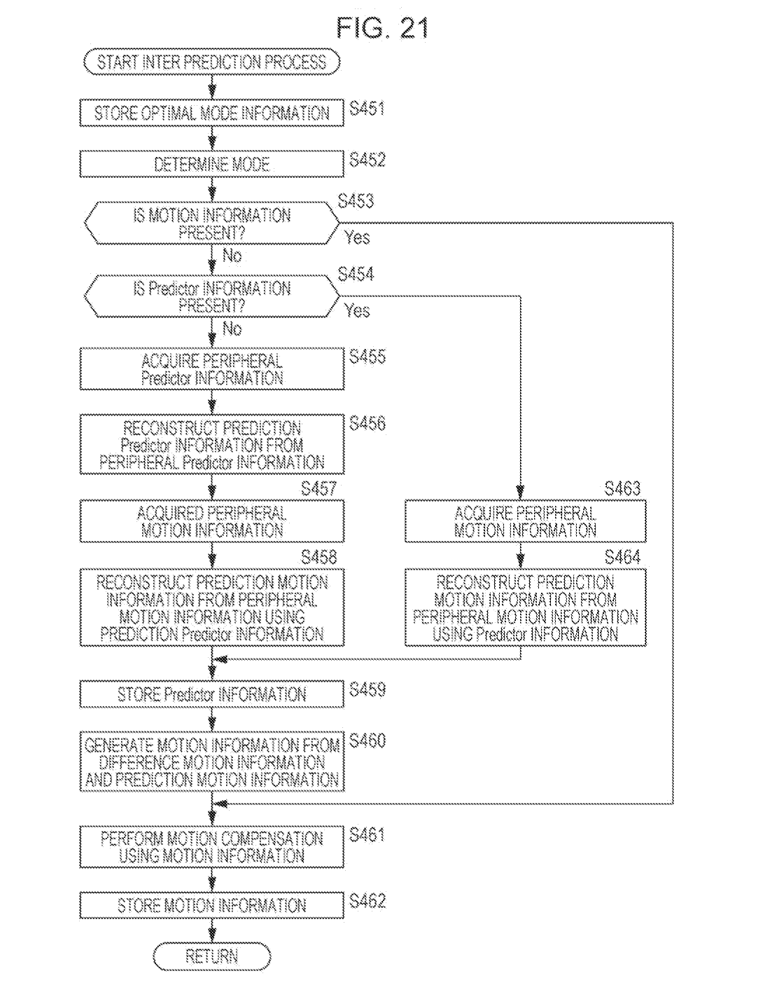

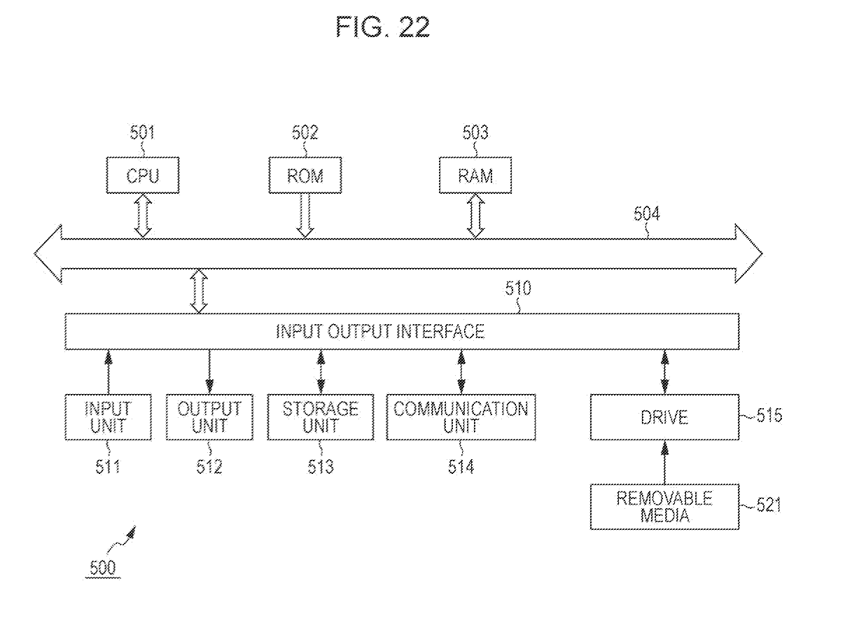

Next, the flow of the inter prediction process executed in Step S434 in FIG. 20 will be explained referring to the flowchart in FIG. 21.

When the inter prediction process is started, in Step S451, the optimal mode information buffer 431 acquires optimal mode information extracted from the encoded data by the lossless decoder 402 and provided from the image encoding device 300, and stores the information.

In Step S452, the mode determination unit 432 determines the mode of the motion prediction employed in the image encoding device 300 based on the optimal mode information stored in the optimal mode information buffer 431 in Step S451.

In Step S453, the mode determination unit 432 determines whether or not the mode is one in which the motion information of the current PU is included in the optimal mode information of the current PU, based on the determination results of Step S452. In a case in which it is determined not to be such a mode, the process of the mode determination unit 432 progresses to Step S454.

In Step S454, the mode determination unit 432 determines whether or not the mode is one in which the Predictor information of the current PU is included in the optimal mode information of the current PU, based on the determination results of Step S452. In a case in which it is determined not to be such a mode, the process of the mode determination unit 432 progresses to Step S455.

In this case, the mode determination unit 432, in the image encoding device 300, determines that a mode predicting the Predictor of the current PU from the Predictor of peripheral PU is employed.

Accordingly, in Step S455, the prediction Predictor information reconstruction unit 441 acquires the peripheral Predictor information from the Predictor information buffer 443. In Step S456, the prediction Predictor information reconstruction unit 441 reconstructs the prediction Predictor information of the current PU from the peripheral Predictor information acquired in Step S455.

In Step S457, the prediction motion information reconstruction unit 442 acquires the peripheral motion information from the motion information buffer 435. In Step S458, the prediction motion information reconstruction unit 442 reconstructs the prediction motion information of the current PU from the peripheral motion information acquired in Step S457, using the prediction Predictor information reconstructed in Step S456.

In Step S459, the Predictor information buffer 443 stores the prediction Predictor information of the current PU (Predictor information) used in Step S458.

In Step S460, the motion information reconstruction unit 442 reconstructs the motion information of the current PU from the difference motion information included in the optimal mode information and the prediction motion information reconstructed in the Step S458.

In Step S461, the motion compensation unit 434 performs motion compensation with respect to the reference image acquired from the frame memory 409 using the motion information reconstructed in Step S460.

In Step S462, the motion information buffer 435 stores the motion information of the current PU used in the motion compensation in Step S461.

When the process of Step S462 finishes, the motion information buffer 435 finishes the inter motion prediction process, provides the process to Step S434 in FIG. 20, and the prediction process is finished.

In addition, in Step S454 in FIG. 21, in a case in which it is determined that the mode is one in which the Predictor information of the current PU is included in the optimal mode information of the current PU, the process of the mode determination unit 432 progresses to Step S463.

In this case, the mode determination unit 432, in the image encoding device 300, determines that a mode predicting the motion vector of the peripheral PU from the motion vector of the current PU is employed.

Accordingly, in Step S463, the prediction motion information reconstruction unit 442 acquires the peripheral motion information from the motion information buffer 435. In Step S464, the prediction motion information reconstruction unit 442 reconstructs the prediction motion information of the current PU from the peripheral motion information acquired in Step S463, using the Predictor information included in the optimal mode information.

When the process of Step S464 finishes, the prediction motion information reconstruction unit 442 returns the process to Step S459, and the subsequent processes are executed using the prediction motion information of the current PU reconstructed by the process of Step S464.

In addition, in Step S453, in a case in which it is determined that the mode is one in which the motion information of the current PU is included in the optimal mode information of the current PU, the process of the mode determination unit 432 progresses to Step S461.

In this case, the mode determination unit 432, in the image encoding device 300, determines that a mode obtaining the motion information of the current PU from the difference input image of the current PU and the prediction image is employed. Accordingly, in this case, the processes subsequent to Step S461 are performed using the motion information of the current PU included in the optimal mode.

As above, the image decoding device 400 is able to realize an improvement in the encoding efficiency of the encoded data output from the image encoding device 300 through executing various processes.

Moreover, above, the Predictor prediction unit 342 and the prediction Predictor information reconstruction unit 441 are explained so as to predict the Predictor of the current PU from the Predictor of the peripheral PU using Expression (20) (description of a case of there being only one selection choice, as in Expression (21) or Expression (22) is omitted). That is, the Predictor prediction unit 342 and prediction Predictor information reconstruction unit 441 were described so as to employ the Predictor of the peripheral PUs with the smallest index as the Predictor of the current PU.

However, the Predictor prediction unit 342 and prediction Predictor information reconstruction unit 441 are not limited thereto, and are able to generate the Predictor of the current PU from the Predictor of the peripheral PU using an arbitrary method. For example, the Predictor of the peripheral PUs for which the index is the greatest may be employed as the Predictor of the current PU, or a Predictor taking the median value of the index may be employed as the Predictor of the current PU.

In addition, above, description was made such that the optimal mode information is included in the encoding data; however, the optimal mode information may accommodate encoding data of an arbitrary position. For example, the data may be accommodated in an NAL (Network Abstraction Layer), such as a sequence parameter set (SPS (Sequence Parameter Set)) or picture parameter set (PPS (Picture Parameter Set)), or may be accommodated in a VCL (Video Coding Layer). In addition, for example, it may also be accommodated in the SEI (Supplemental Enhancement Information), or the like.

Furthermore, the optimal mode information may be transmitted to the decoding side separately to the encoded data. In this case, there is a need to clarify the correspondence relationship between the optimal mode information and the encoded data (so as to be able to ascertain on the decoding side); however, the method may be arbitrary. For example, separate table information indicating the correspondence relationship may be created, or link information indicating a correspondence destination may be embedded in each data item.

In addition, above, description has been made so as to use the PU as the processing unit (prediction processing unit) of the intra prediction or inter prediction (including processes, such as motion search (generation of motion information), prediction of motion vector (generation of difference motion information), prediction of Predictor (generation of prediction Predictor information), reconstruction of prediction Predictor information, reconstruction of prediction motion information, and reconstruction of motion information); however, the prediction processing unit may be an arbitrary unit other than the PU. For example, the unit may be a CU, TU, macroblock or submacroblock, or the like, or may be another region (block). In other words, regions of arbitrary size, such as a CU, PU, TU, macroblock, submacroblock or the like are included in regions (block) set as prediction processing units.

Accordingly, for example, the current PU which is a processing target is also known as a current block. In addition, the above-described peripheral PU, adjacent PU and neighboring PU are also respectively known as a peripheral block, adjacent block and neighboring block. Furthermore, a PU adjacent to the upper portion, a PU adjacent to the left portion, a PU adjacent to the upper-left portion, and a PU adjacent to the upper right portion of the current PU are also respectively known as upper adjacent block, left adjacent block, upper-left adjacent block and upper-right adjacent block. In addition, a PU adjacent in the time direction to the current PU so as to be co-located is also known as a Co-located block.

### 3. Third Embodiment

### Personal Computer

The above-described series of processes may be executed by hardware or may also be executed by software. In this case, for example, configuration may be made as a personal computer as shown in FIG. 22.

In FIG. 22, the CPU (Central Processing Unit) 501 of the personal computer 500 executes various processes according to a program stored in a ROM (Read Only Memory) 502, or a program loaded to a RAM (Random Access Memory) 503 from the storage unit 513. The RAM 503 or CPU 501 appropriately stores data needed in the execution of various processes.

The CPU 501, ROM 502 and RAM 503 are mutually connected via a bus 504. An input and output interface 510 is also connected to the bus 504.

An input unit 511 formed by a keyboard, mouse or the like, an output unit 512 formed of a display formed from a CRT (Cathode Ray Tube) or LCD (Liquid Crystal Display) or the like, and a speaker or the like, a storage unit 513 configured by a hard disk or the like, and communication unit 514 configured of modem or the like are connected to the input and output interface 510. The communication unit 514 performs a communication process via a network including the Internet.

A drive 515 is further connected as needed to the input and output interface 510, a removable medium 521, such as a magnetic disk, optical disc, magneto-optical disc or a semi-conductor memory is appropriately equipped, and a computer program read out therefrom is installed to the storage unit 513 as needed.

In a case where the above-described series of processes is executed through software, the program configuring the software is installed from a network or a storage medium.

The recording medium, as shown in FIG. 22, for example, is not only configured separate to the device main body by a magnetic disk (including a flexible disk), optical disc (including a CD-ROM (Compact Disk-Read Only Memory) or DVD (Digital Versatile Disc)), magneto-optical disc (including an MD (Mini-Disc)) or a removable medium 521 formed from a semi-conductor memory on which a program is recorded and distributed for delivery of the program to a user, but also may be configured of a ROM 502, a hard disk included in the storage unit 513, or the like, on which the program is recorded and delivered to the user in a state incorporated in advance to the device main body.

Moreover, the program executed by the computer may be a program in which the processes are performed chronologically following an order described in the specification, or may be a program in which the processes are performed in parallel or at a needed timing, such as when called.

In addition, in the specification, the step describing the program recorded on the recording medium are naturally processes performed in chronological order following the order disclosed, but are not necessarily only processed in chronological order, and processes executed in parallel or separately are included.

In addition, in the specification, system indicates an overall device configured by a plurality of devices (device).

In addition, above, the configuration described as a single device (or processing unit) may be divided and configured by a plurality of devices (or processing units). Conversely, a configuration described above as a plurality of devices (or processing units) may be configured by collecting as a single device (or processing unit). In addition, a configuration other than the above may naturally be added to the configuration of each device (or each processing unit). Furthermore, if the overall system configuration or operation is substantially the same, a portion of the configuration of a given device (or processing unit) may be included in the configuration of another device (or another processing unit). In other words, embodiments of the present technology are not limited to the above-described embodiments, and various modifications are possible in a range not departing from the gist of the present technology.

For example, the motion prediction and compensation unit 315 and motion information prediction unit 321 shown in FIG. 12 may be respectively configured as independent devices. In addition, the motion search unit 331, cost function calculation unit 332, mode determination unit 333, motion compensation unit 334, motion information buffer 335, motion prediction unit 341, Predictor prediction unit 342, comparison determination unit 343 and flag generation unit 344 shown in FIG. 12 may be respectively configured as independent devices.

In addition, these various processing units may be arbitrarily combined and configured as independent devices. Naturally, these may be combined with arbitrary processing units shown in FIG. 11 and FIG. 12, and may be combined with processing units not shown in the diagrams.

The same applies to image decoding device 400. For example, the motion prediction and compensation unit 412 and motion information prediction unit 421 shown in FIG. 19 may be respectively configured as independent devices. In addition, the optimal mode information buffer 431, mode determination unit 432, motion information reconstruction unit 433, motion compensation unit 434, motion information buffer 435, prediction Predictor information reconstruction unit 441, prediction motion information reconstruction unit 442, and Predictor information buffer 443 shown in FIG. 19 may be respectively configured as independent devices.

In addition, these various processing units may be arbitrarily combined and configured as independent devices. Naturally, these may be combined with arbitrary processing units shown in FIG. 18 and FIG. 19, and may be combined with processing units not shown in the diagrams.

In addition, for example, the above-described image encoding device or image decoding device may be applied to an arbitrary electronic device. Below, examples will be described.

### 4. Fourth Embodiment

### Television Receiver

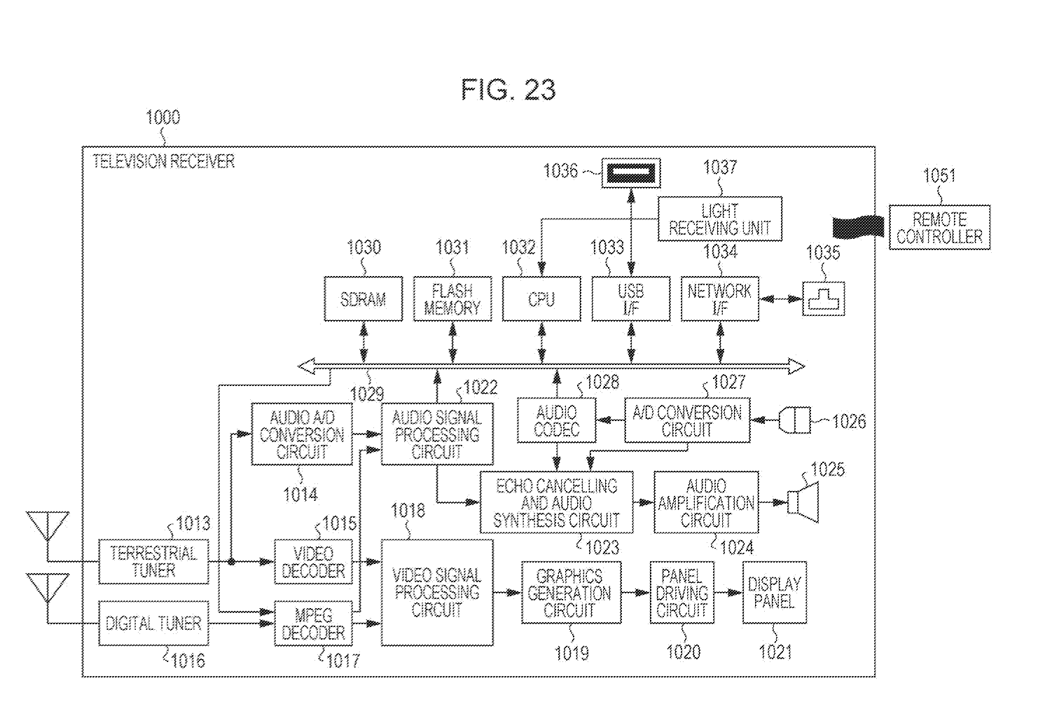

FIG. 23 is a block diagram showing a main configuration example of a television receiver using the image decoding device 400.

The television receiver 1000 shown in FIG. 23 includes a terrestrial tuner 1013, a video decoder 1015, a video signal processing circuit 1018, a graphics generation circuit 1019, a panel driving circuit 1020 and a display panel 1021.

The terrestrial tuner 1013 receives a broadcast wave signal of a terrestrial analog broadcast via an antenna, demodulated the signal, acquires a video signal and provides these to the video decoder 1015. The video decoder 1015 performs a decoding process with respect to the video signal provided from the terrestrial tuner 1013, and provides the obtained digital component signal to the video signal processing circuit 1018.

The video signal processing circuit 1018 performs a predetermined process, such as noise removal, with respect to video data provided from the video decoder 1015, and provides the obtained video data to the graphics generation circuit 1019.

The graphics generation circuit 1019 generates video data of a program displayed on the display panel 1021 or image data through a process based on an application provided via a network, and provides the generated video data or image data to the panel driving circuit 1020. In addition, the graphics generation circuit 1019 generates video data (graphics) for display of a screen used by a user in selection or the like of an item, and appropriately performs a process such as providing the video data obtained by superimposing the data on the video data of the program to the panel driving circuit 1020.

The panel driving circuit 1020 drives the display panel 1021 based on data provided from the graphics generation circuit 1019, and causes the display panel 1021 to display video of a program or various screens described above.

The display panel 1021 is formed from an LCD (Liquid Crystal Display) or the like, and displays video of a program, or the like, according to control by the panel driving circuit 1020.

In addition, the television receiver 1000 also includes an audio A/D (Analog/Digital) conversion circuit 1014, an audio signal processing circuit 1022, an echo canceling and audio synthesis circuit 1023, an audio amplification circuit 1024 and speaker 1025.

The terrestrial tuner 1013 acquires not only video signals but also audio signals by demodulating received broadcast wave signals. The terrestrial tuner 1013 provides the acquired audio signal to the audio A/D conversion circuit 1014.

The audio A/D conversion circuit 1014 performs an A/D conversion process with respect to the audio signal provided from the terrestrial tuner 1013, and provides the obtained digital audio signal to the audio signal processing circuit 1022.

The audio signal processing circuit 1022 performs a predetermined process, such as noise removal, with respect to the audio data provided from the audio A/D conversion circuit 1014, and provides the obtained audio data to the echo canceling and audio synthesis circuit 1023.

The echo canceling and audio synthesis circuit 1023 provides the audio data provided from the audio signal processing circuit 1022 to the audio amplification circuit 1024.

The audio amplification circuit 1024 performs a D/A conversion process and an amplification process with respect to the audio data provided from the echo canceling and audio synthesis circuit 1023, and outputs audio from the speaker 1025 after modulating to a predetermined volume.

Furthermore, the television receiver 1000 also includes a digital tuner 1016 and an MPEG decoder 1017.

The digital tuner 1016 receives broadcasts wave signals of a digital broadcast (terrestrial digital broadcast, BS (Broadcasting Satellite)/CS (Communications Satellite) digital broadcasts) via an antenna, demodulates the signals, acquires the MPEG-TS (Moving Picture Experts Group-Transport Stream) and provides this to the MPEG decoder 1017.

The MPEG decoder 1017 clears the scrambling performed on the MPEG-TS provided from the digital tuner 1016, and extracts a stream including data of a program which is a reproduction target (viewing target). The MPEG decoder 1017 decodes the audio packets configuring the extracted stream, along with providing the obtained audio data to the audio signal processing circuit 1022, decodes the video packets configuring the stream and provides the obtained video data to the video signal processing circuit 1018. In addition, the MPEG decoder 1017 provides the EPG (Electronic Program Guide) data extracted from the MPEG-TS to the CPU 1032 via a route not shown in the drawing.

The television receiver 1000 uses the above-described image decoding device 400 as the MPEG decoder 1017 decoding such video packets. Moreover, the MPEG-TS transmitted by a broadcast station or the like is encoded by the image encoding device 300.

The MPEG decoder 1017, similarly to the case of the image decoding device 400, reconstructs the prediction Predictor information of the current PU from the Predictor information of the peripheral PU, reconstructs the prediction motion information of the current PU using this reconstructed prediction Predictor information, reconstructs the motion information of the current PU using this reconstructed prediction motion information, performs motion compensation using this reconstructed motion information and appropriately generates an inter encoded prediction image. Accordingly, the MPEG decoder 1017 is able to appropriately decode encoded data generated using a mode predicting the Predictor of the current PU from the Predictor of the peripheral PU in the encoding side. In so doing, the MPEG decoder 1017 is able to realize improvement in encoding efficiency.

The video data provided from the MPEG decoder 1017, similarly to the case of the video data provided from the video decoder 1015, is subjected to a predetermined process in the video signal processing circuit 1018, generated video data or the like is appropriately superimposed in the graphics generation circuit 1019, is provided to the display panel 1021 via the panel driving circuit 1020 and an image is displayed.

The audio data provided from the MPEG decoder 1017, similarly to the case of the audio data provided from the audio A/D conversion circuit 1014, is subjected to a predetermined process in the audio signal processing circuit 1022, is provided to the audio amplification circuit 1024 via the echo canceling and audio synthesis circuit 1023 and is subjected to a D/A conversion process or an amplification process. As a result, the audio modulated to a predetermined volume is output from a speaker 1025.

In addition, the television receiver 1000 also includes a microphone 1026 and A/D conversion circuit 1027.

The A/D conversion circuit 1027 receives the audio signal of a user incorporated by the microphone 1026 provided in the television receiver 1000 as an audio conversation device, performs an A/D conversion process with respect to the received audio signal, and provides the obtained digital audio data to the echo canceling and audio synthesis circuit 1023.

The echo canceling and audio synthesis circuit 1023, in the case of audio data of a user (user A) of the television receiver 1000 being provided from the A/D conversion circuit 1027, performs echo cancellation on the audio data of user A as a target, and the audio data obtained by synthesizing, or the like, with other audio data is output by the speaker 1025 via the audio amplification circuit 1024.

Furthermore, the television receiver 1000 includes an audio codec 1028, an internal bus 1029, an SDRAM (Synchronous Dynamic Random Access Memory) 1030, a flash memory 1031, CPU 1032, a USB (Universal Serial Bus) I/F 1033 and a network I/F 1034.

The A/D conversion circuit 1027 receives the audio signal of a user incorporated by the microphone 1026 provided in the television receiver 1000 as an audio conversation device, performs an A/D conversion process with respect to the received audio signal, and provides the obtained digital audio data to the audio codec 1028.

The audio coded 1028 converts the audio data provided from the A/D conversion circuit 1027 to data of a predetermined format for transmission through a network and provides the data to the network I/F 1034 via an internal bus 1029.

The network I/F 1034 is connected to the network via a cable attached to a network terminal 1035. The network I/F 1034 transmits audio data provided from the audio codec 1028, for example, with respect to another device connected to the network. In addition, the network I/F 1034, receives the audio data transmitted from another device connected via the network through the network terminal 1035, for example, and provides the data to the audio codec 1028 via the internal bus 1029.

The audio codec 1028 converts the audio data provided from the network I/F 1034 to data of a predetermined format, and provides this to the echo canceling and audio synthesis circuit 1023.

The echo canceling and audio synthesis circuit 1023, performs echo cancellation on the audio data provided from the audio codec 1028, and the audio data obtained by synthesizing, or the like, with other audio data is output by the speaker 1025 via the audio amplification circuit 1024.

The SDRAM 1030 stores various types of data required in performance of processing by the CPU 1032.

The flash memory 1031 stores the program executed by the CPU 1032. The programs stored in the flash memory 1031 is read out by the CPU 1032 at a predetermined timing, such as when the television receiver 1000 is activated. EPG data acquired via a digital broadcasts, data acquired from a predetermined server via the network, or the like, is also stored in the flash memory 1031.

For example, MPEG-TS including content data acquired from a predetermined server via the network by control of the CPU 1032 is stored in the flash memory 1031. The flash memory 1031 provides the MPEG-TS to the MPEG decoder 1017 via the internal bus 1029, for example, by control of the CPU 1032.

The MPEG decoder 1017, similarly to the case of the MPEG-TS provided from the digital tuner 1016, processes the MPEG-TS. Such a television receiver 1000 receives content data formed of video and audio, or the like, via the network, decodes the data using the MPEG decoder 1017, and is able to display the video or output the audio.

In addition, the television receiver 1000 includes a light receiving unit 1037 receiving an infrared signal transmitted from the remote controller 1051.

The light receiving unit 1037 receives infrared rays from the remote controller 1051, and outputs a control code indicating the content of a user operation obtained through demodulation to the CPU 1032.

The CPU 1032 executes the program stored in the flash memory 1031, and controls the overall operation of the television receiver 1000 according to a control code, or the like, provided from the light receiving unit 1037. The respective units of the CPU 1032 and the television receiver 1000 are connected via a route not shown in the diagram.

The USB I/F 1033 performs transmission and reception of data with an external device of the television receiver 1000 connected via a USB cable attached to a USB terminal 1036. The network I/F 1034 is connected to the network via a cable attached to a network terminal 1035, and also performs transmission and reception of data other than audio data with various devices connected to the network.

The television receiver 1000 is able to realize improvement in encoding efficiency of broadcast wave signals received via an antenna or content data acquired via the network by using the image decoding device 400 as the MPEG decoder 1017.

### 5. Fifth Embodiment

### Portable Telephone

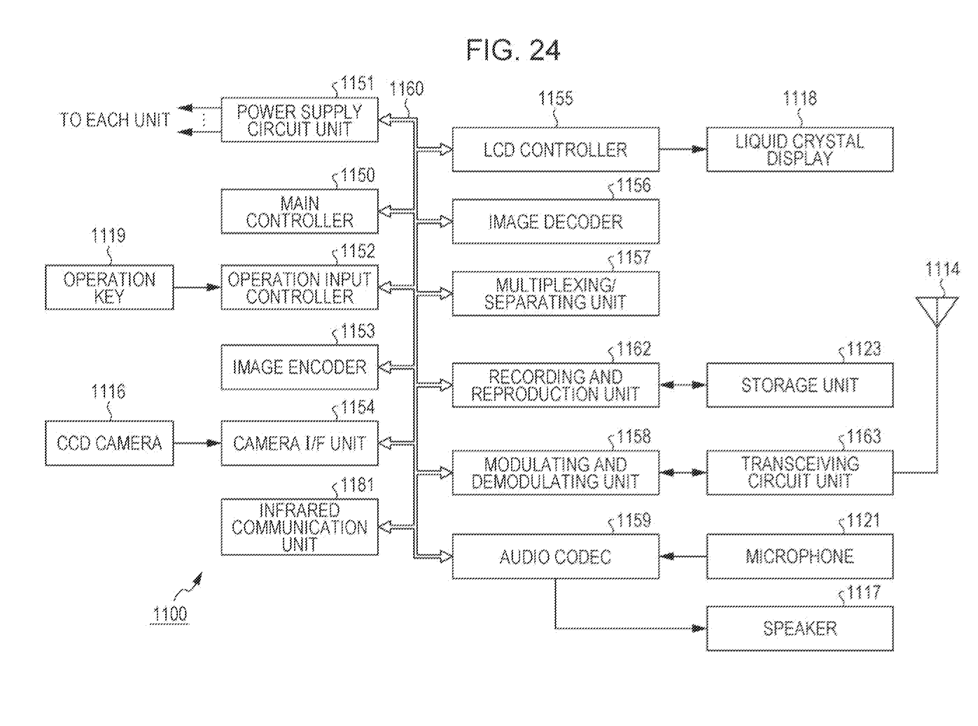

FIG. 24 is a block diagram showing a main configuration example of portable telephone using the image encoding device 300 and image decoding device 400.

The portable telephone 1100 shown in FIG. 24 includes a main controller 1150 configured so as to integrally control each unit, a power supply circuit unit 1151, an operation input controller 1152, an image encoder 1153, a camera I/F 1154, and LCD controller 1155, an image decoder 1156, a multiplexing and separating unit 1157, a recording and reproduction unit 1162, a modulation and demodulation circuit unit 1158 and an audio codec 1159. These are mutually connected via a bus 1160.

In addition, the portable telephone 1100 includes operation keys 1119, a CCD (Charge Coupled Device) camera 1116, a liquid crystal display 1118, a storage unit 1123, a transmission and reception circuit unit 1163, an antenna 1114, a microphone (mike) 1121 and a speaker 1117.

The power source circuit unit 1151, when a call is ended by an operation of the user and the power key is set to an on state, activates the portable telephone 1100 to an operable state by providing power from a battery pack with respect to each unit.

The portable telephone 1100 performs various operations, such as transmission and reception of audio signals, transmission and reception of electronic mail or image data, image capture or data storage in various modes, such as an audio calling mode or data communication mode, based on control by the main controller 1150 formed from the CPU, ROM and RAM or the like.

For example, in the audio calling mode, the portable telephone 1100 converts audio signals collected by the microphone (mike) 1121 to digital audio data using the audio codec 1159, performs spectrum spread processing thereupon with the modulation and demodulation circuit unit 1158, and performs digital analog conversion processing and frequency conversion processing with the transmission and reception circuit unit 1163. The portable telephone 1100 transmits the transmission signal obtained by the conversion processes to a base station not shown in the diagram via an antenna 1114. The transmission signal (audio signal) transmitted to the base station is provided to the portable telephone of the conversation counterparty via a public telephone network.

In addition, for example, in the audio calling mode, the portable telephone 1100 amplifies the received signal received by the antenna 1114 with the transmission and reception circuit unit 1163, further performs a frequency conversion processing and analog digital conversion process, performs spectrum spread processing using the modulation and demodulation circuit unit 1158, and converts the analog audio signal using the audio codec 1159. The portable telephone 1100 outputs the analog audio signal obtained by this conversion from the speaker 1117.

Furthermore, for example, in the case of transmitting an electronic mail in the data transmission mode, the portable telephone 1100 receives text data of an electronic mail input by an operation of the operation keys 1119 in the operation input controller 1152. The portable telephone 1100 processes the text data in the main controller 1150, and displays the data as an image on the liquid crystal display 1118 via the LCD controller 1155.

In addition, the portable telephone 1100 generates electronic mail data based on text data received by the operation input controller 1152 or user instruction or the like, in the main controller 1150. The portable telephone 1100 performs spectrum spread processing on the electronic mail data using the modulation and demodulation circuit 1158, and performs digital analog conversion processing and frequency conversion processing using the transmission and reception circuit unit 1163. The portable telephone 1100 transmits the transmission signal obtained by the conversion processes to a base station not shown in the diagram via an antenna 1114. The transmission signal (electronic mail) transmitted to the base station is provided to a predetermined destination via a network and mail server and the like.

In addition, for example, in the case of receiving an electronic mail in the data communication mode, the portable telephone 1100 receives the signal transmitted from the base station using the transmission and reception circuit unit 1163 via the antenna 1114, amplifies the signal, and further performs a frequency conversion processing and analog digital conversion processing. The portable telephone 1100 restores the original electronic mail data by performing spectrum spread processing of the received signal using the modulation and demodulation circuit unit 1158. The portable telephone 1100 displays the restored electronic mail data on the liquid crystal display 1118 via the LCD controller 1155.

Moreover, the portable telephone 1100 is able to record (store) the received electronic mail data in the storage unit 1123 via the recording and reproduction unit 1162.

The storage unit 1123 is a rewritable arbitrary storage medium. The storage unit 1123 may be, for example, a semi-conductor memory, such as a RAM or a built-in flash memory, may be a hard disk, or may be a removable medium, such as a magnetic disk, magneto-optical disc, optical disc, USB memory or memory card. Naturally, memories other than these may be used.

Furthermore, for example, in a case of transmitting image data in the data transmission mode, the portable telephone 1100 generates image data with the CCD camera 1116 through image capture. The CCD camera 1116 includes an optical device, such as a lens or aperture, and a CCD as an electro-optical conversion element, captures the image of a subject, converts the intensity of the received light to an electrical signal and generates image data of an image of the subject. The CCD camera 1116 encodes this image data with the image encoder 1153 via the camera I/F unit 1154, and converts the data to encoded image data.

The portable telephone 1100 uses the above-described image encoding device 300 as the image encoder 1153 performing such processes. The image encoder 1153, similarly to the case of the image encoding device 300, generates a prediction image in a mode predicting the Predictor of the current PU from the Predictor of the peripheral PU, and generates encoded data using the prediction image. That is, the image encoder 1153 is able to not perform encoding of the Predictor information. In so doing, the image encoder 1153 is able to realize improvements in encoding efficiency.

Moreover, at the same time, the portable telephone 1100 performs analog digital conversion in the audio codec 1159 of the audio collected by the microphone (mike) 1121 during image capture with the CCD camera 1116, and further encodes this.

The portable telephone 1100 multiplexes the encoded image data provided from the image encoder 1153 and the digital audio data provided from the audio codec 1159 using a predetermined method in the multiplexing and separating unit 1157. The portable telephone 1100 performs spectrum spread processing on the multiplexed data obtained as a result with the modulation and demodulation circuit unit 1158 and performs a digital and analog conversion process and frequency conversion process using the transmission and reception circuit unit 1163. The portable telephone 1100 transmits the transmission signal obtained by the conversion processes to a base station not shown in the diagram via an antenna 1114. The transmission signal (image data) transmitted to the base station is provided to a communication counterparty via a network or the like.

Moreover, in a case where image data is not transmitted, the portable telephone 1100 is able to display the image data generated by the CCD camera 1116 on the liquid crystal display 1118 via the LCD controller 1155 without passing through the image encoder 1153.

In addition, for example, in the data communication mode, in a case of receiving data of a moving image file linked to a simple homepage, the portable telephone 1100 receives the signal transmitted from the base station via the antenna 1114 using the transmission and reception circuit unit 1163, amplifies the signal and further performs frequency conversion processing and analog and digital conversion processing thereon. The portable telephone 1100 restores the original multiplexed data by performing spectrum spread processing on the received signal using the modulation and demodulation circuit unit 1158. The portable telephone 1100, in the multiplexing and separating unit 1157, separates the multiplexed data and divides the encoded image data and the audio data.

The portable telephone 1100 generates reproduction image data, and display this on the liquid crystal display 1118 via the LCD controller 1155 by decoding the encoded image data in the image decoder 1156. In so doing, for example, moving image data included in the moving image file linked to a simple homepage is displayed on the liquid crystal display 1118.

The portable telephone 1100 uses the above-described image decoding device 400 as the image decoder 1156 performing such processes. That is, the image decoder 1156, similarly to the case of the image decoding device 400, reconstructs the prediction Predictor information of the current PU from the Predictor information of the peripheral PU, reconstructs the prediction motion information of the current PU using this reconstructed prediction Predictor information, reconstructs the motion information of the current PU using this reconstructed prediction motion information, performs motion compensation using this reconstructed motion information and appropriately generates an inter encoded prediction image. Accordingly, the image decoder 1156 is able to appropriately decode encoded data generated using a mode predicting the Predictor of the current PU from the Predictor of the peripheral PU in the encoding side. In so doing, the image decoder 1156 is able to realize improvement in encoding efficiency.

At this time, the portable telephone 1100, at the same time, converts the digital audio data to analog audio data in the audio codec 1159 and this is output by the speaker 1117. In so doing, for example, audio data included in the moving image file linked to the simple homepage is reproduced.

Moreover, similarly to the case of electronic mail, the portable telephone 1100 is able to record (store) the received data linked to a simple home page, or the like, in the storage unit 1123 via the recording and reproduction unit 1162.

In addition, the portable telephone 1100 analyzes, in the main controller 1150, a two-dimensional code obtained by the CCD camera 1116 by image capture, and is able to acquire information recorded in the two-dimensional code.

Furthermore, the portable telephone 1100 is able to communicate with external devices by infrared rays using the infrared communication unit 1181.

The portable telephone 1100, when transmitting by encoding image data generated in the CCD camera 1116, for example, is able to improve the encoding efficiency of the encoded data by using the image encoding device 300 as the image encoder 1153.

In addition, the portable telephone 1100 is able to realize improvement in encoding efficiency of data (encoded data) of a moving image file linked to a simple home page or the like, for example, by using the image decoding device 400 as the image decoder 1156.

Moreover, above, the portable telephone 1100 was described using the CCD camera 1116; however, an image sensor (CMOS image sensor) in which a CMOS (Complementary Metal Oxide Semiconductor) is used instead of the CCD camera 1116 may be used. In this case as well, the portable telephone 1100, similarly to the case of using the CCD camera 1116, captures the image of a subject and is able to generate image data of an image of the subject.

In addition, description was made as a portable telephone 1100 above; however, any device may apply the image encoding device 300 and image decoding device 400 of the embodiment in the same manner to the case of the portable telephone 1100 as long as the device has an image capture function and communication function similar to the portable telephone 1100, such as PDAs (Personal Digital Assistant), smartphones, UPMCs (Ultra Mobile Personal Computer), netbooks, notebook personal computers or the like.

### 6. Sixth Embodiment

### Hard Disk Recorder

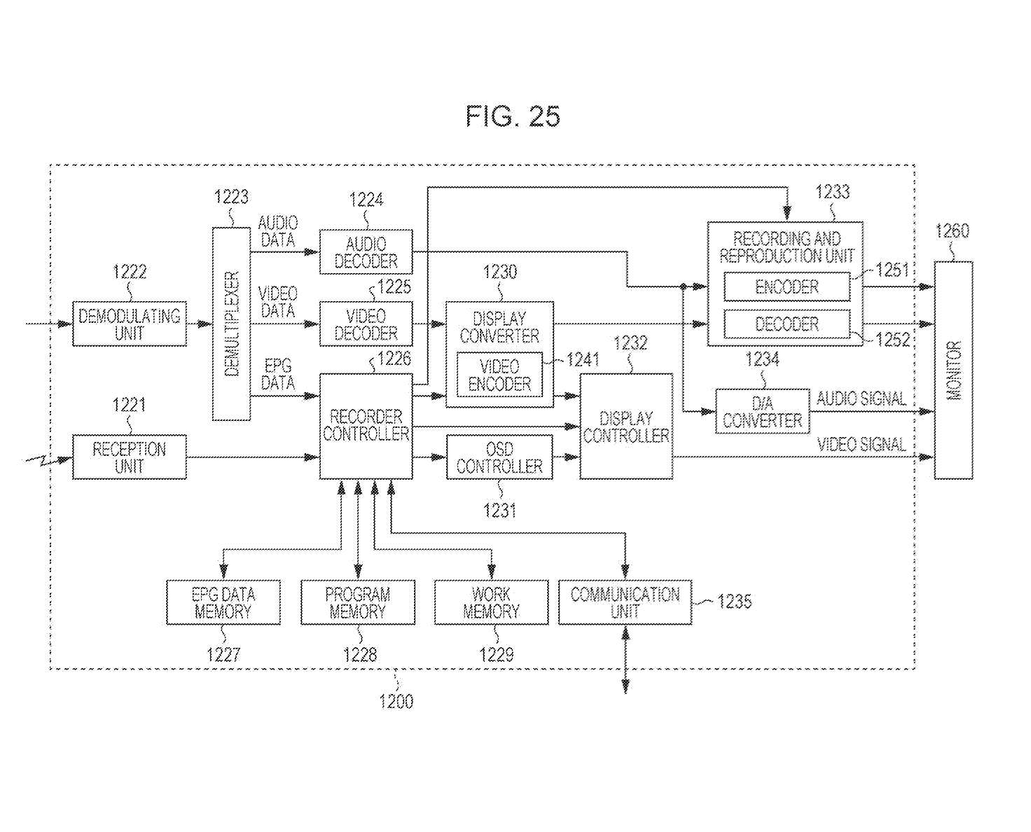

FIG. 25 is a block diagram showing a main configuration example of hard disk recorder using the image encoding device 300 and image decoding device 400.

The hard disk recorder (HDD recorder) 1200 shown in FIG. 25 is a device saving, on a built-in hard disk, audio data and video data of a broadcast program included in broadcast signals (television signals) received by a tuner and transmitted by satellite or a terrestrial antenna or the like, and providing the saved data to a user at a timing according to instructions of the user.

The hard disk recorder 1200, for example, extracts audio data and video data from a broadcast signal, appropriately decodes these and is able to record the data on a built-in hard disk. In addition, the hard disk recorder 1200, for example, acquires audio data and video data from another device via a network, appropriately decodes these and is able to record the data on a built-in hard disk.

Furthermore, the hard disk recorder 1200, for example, provides audio data and video data recorded on the built-in hard disk to a monitor 1260 by decoding, displays the image on the screen of the monitor 1260, and is able to output audio using a speaker of the monitor 1260. In addition, the hard disk recorder 1200, for example, provides audio data and video data extracted from a broadcast signal acquired via a tuner or audio data and video data acquired from another device via a network to the monitor 1260 by decoding, displays the image on the screen of the monitor 1260, and is able to output audio using the speaker of the monitor 1260.

Naturally, other operations are possible.

As shown in FIG. 25, the hard disk recorder 1200 includes a receiving unit 1221, a demodulating unit 1222, a demultiplexer 1223, an audio decoder 1224, a video decoder 1225 and a recorder controller 1226. The hard disk recorder 1200 further includes an EPG data memory 1227, a program memory 1228, a work memory 1229, a display converter 1230, and OSD (On Screen Display) controller 1231, a display controller 1232, a recording and reproduction unit 1233, a D/A converter 1234 and a communication unit 1235.

In addition, the display controller 1230 includes a video encoder 1241. The recording and reproduction unit 1233 includes and encoder 1251 and a decoder 1252.

The receiving unit 1221 receives infrared signals from a remote controller (not shown), and outputs by conversion to an electrical signal to the recorder controller 1226. The recorder controller 1226, for example, is configured by a microprocessor or the like, and executes a variety of processes according to a program recorded in the program memory 1228. The recorder controller 1226 uses the work memory 1229 at this time as needed.

The communication unit 1235 is connected to a network and performs a communication process with other devices via the network. For example, the communication unit 1235 is controlled by the recorder controller 1226, communicates with a tuner (not shown), and mainly outputs a channel selection control signal with respect to the tuner.

The demodulation unit 1222 demodulates a signal provided by the tuner and outputs the signal to the demultiplexer 1223. The demultiplexer 1223 separates data provided by the demodulation unit 1222 into audio data, video data and EPG data, and respectively outputs these to the audio decoder 1224, video decoder 1225 or recorder controller 1226.

The audio decoder 1224 decodes the input audio data and outputs the data to the recording and reproduction unit 1233. The video decoder 1225 decodes the input video data and outputs the data to the display converter 1230. The recorder controller 1226 provides the input EPG data to the EPG data memory 1227 and causes the data to be stored.

The display converter 1230 encodes the video data provided by the video decoder 1225 or the recorder controller 1226 as video data in the NTSC (National Television Standards Committee) format, for example, using the video encoder 1241 and outputs the data to the recording and reproduction unit 1233. In addition, the display converter 1230 converts the screen size of the video data provided by the video decoder 1225 or the recorder controller 1226 to a size corresponding to the size of the monitor 1260, and converts the data to video data of the NTSC format by the video encoder 1241, converts this to an analog signal and outputs the signal to the display controller 1232.

The display controller 1232, along with control of the recorder controller 1226, superimposes an OSD signal output by the OSD (On Screen Display) controller 1231 on the video signal input by the display converter 1230, outputs this to the display of the monitor 1260 and displays the image.

Audio data output by the audio decoder 1224 is further provided to the monitor 1260 by being converted to an analog signal by the D/A converter 1234. The monitor 1260 outputs the audio signal from a built-in speaker.

The recording and reproduction unit 1233 includes a hard disk as a storage medium recording video data or audio data or the like.

The recording and reproduction unit 1233, for example, encodes the audio data provided by the audio decoder 1224 with the encoder 1251. In addition, the recording and reproduction unit 1233 encodes video data provided by the video encoder 1241 of the display converter 1230 with the encoder 1251. The recording and reproduction unit 1233 synthesizes the encoded data of the audio data and encoded data of the video data with the multiplexer. The recording and reproduction unit 1233 amplifies by channel coding the synthesis data, and writes this data to the hard disk via a recording head.

The recording and reproduction unit 1233 reproduces the data recorded on the hard disk via the reproduction head, amplifies the data and separates the data into audio data and video data with the demultiplexer. The recording and reproduction unit 1233 decodes the audio data and video data with the decoder 1252. The recording and reproduction unit 1233 performs D/A conversion of the decoded audio data and outputs the data to the speaker of the monitor 1260. In addition, the recording and reproduction unit 1233 performs D/A conversion of the decoded video data and outputs the data to the display of the monitor 1260.

The recorder controller 1226 reads out the latest EPG data from the EPG data memory 1227 based on a user instruction indicated by an infrared signal from the remote controller received via the receiving unit 1221, and provides this to the OSD controller 1231. The OSD controller 1231 generates image data corresponding to the input EPG data and outputs the data to the display controller 1232. The display controller 1232 outputs the video data input by the OSD controller 1231 to the display of the monitor 1260 and displays the image. In so doing, the EPG (electronic program guide) is displayed on the display of the monitor 1260.

In addition, the hard disk recorder 1200 is able to acquire a variety of data, such as video data, audio data or EPG data provided from another device via a network such as the Internet.

The communication unit 1235 is controlled by the recorder controller 1226, acquires encoded data, such as video data, audio data and EPG data, transmitted from another device via the network, and provides this to the recorder controller 1226. The recorder controller 1226, for example, provides encoded data of acquired video data or audio data to the recording and reproduction unit 1233 and records the data on the hard disk. At this time, the recorder controller 1226 and recording and reproduction unit 1233 may perform a process such as re-encoding as needed.

In addition, the recorder controller 1226 decodes the encoded data of acquired video data or audio data and provides the obtained video data to the display converter 1230. The display converter 1230, similarly the video data provided from the video decoder 1225, processes the video data provided from the recorder controller 1226, provides the data to the monitor 1260 via the display controller 1232 and displays the image.

In addition, matched to the image display, the recorder controller 1226 may provide the decoded audio data to the monitor 1260 via the D/A converter 1234 and output this audio from a speaker.

Furthermore, the recorder controller 1226 decodes the encoded data of the acquired EPG data, and provides the decoded EPG data to the EPG memory 1227.

The hard disk recorder 1200 such as above uses the image decoding device 400 as a decoder built into the video decoder 1225, decoder 1252 and recorder controller 1226. That is, the decoder built into the video decoder 1225, decoder 1252 and recorder controller 1226, similarly to the case of the image decoding device 400, reconstructs the prediction Predictor information of the current PU from the Predictor information of the peripheral PU, reconstructs the prediction motion information of the current PU using this reconstructed prediction Predictor information, reconstructs the motion information of the current PU using this reconstructed prediction motion information, performs motion compensation using this reconstructed motion information and appropriately generates an inter encoded prediction image. Accordingly, the decoder built into the video decoder 1225, decoder 1252 and recorder controller 1226 is able to appropriately decode encoded data generated using a mode predicting the Predictor of the current PU from the Predictor of the peripheral PU in the encoding side. In so doing, the decoder built into the video decoder 1225, decoder 1252 and recorder controller 1226 is able to realize improvement in encoding efficiency.

Accordingly, the hard disk recorder 1200, for example, is able to realize an improvement in the encoding efficiency of the video data (encoded data) received by the tuner or communication unit 1235 or the video data (encoded data) reproduced by the recording and reproduction unit 1233.

In addition, the hard disk recorder 1200 uses the image encoding device 300 as the encoder 1251. Accordingly, the encoder 1251, similarly to the case of the image encoding device 300, generates a prediction image in a mode predicting the Predictor of the current PU from the Predictor of the peripheral PU, and generates encoded data using the prediction image. Accordingly, the encoder 1251 is able to not perform encoding of the Predictor information. In so doing, the encoder 1251 is able to realize improvements in encoding efficiency.

Accordingly, the hard disk recorder 1200, for example, is able to realize an improvement in the encoding efficiency of the encoded data recorded on the hard disk.

Moreover, above, description has been made regarding a hard disk recorder 1200 recording video data or audio data on a hard disk; however, any type of recording medium may be used. For example, even in a recorder applying a recording medium other than a hard disk, such as a flash memory, optical disc or video tape, similarly to the case of the above-described hard disk recorder 1200, it is possible to apply the image encoding device 300 and image decoding device 400 of the embodiment.

### 7. Seventh Embodiment

### [Camera]

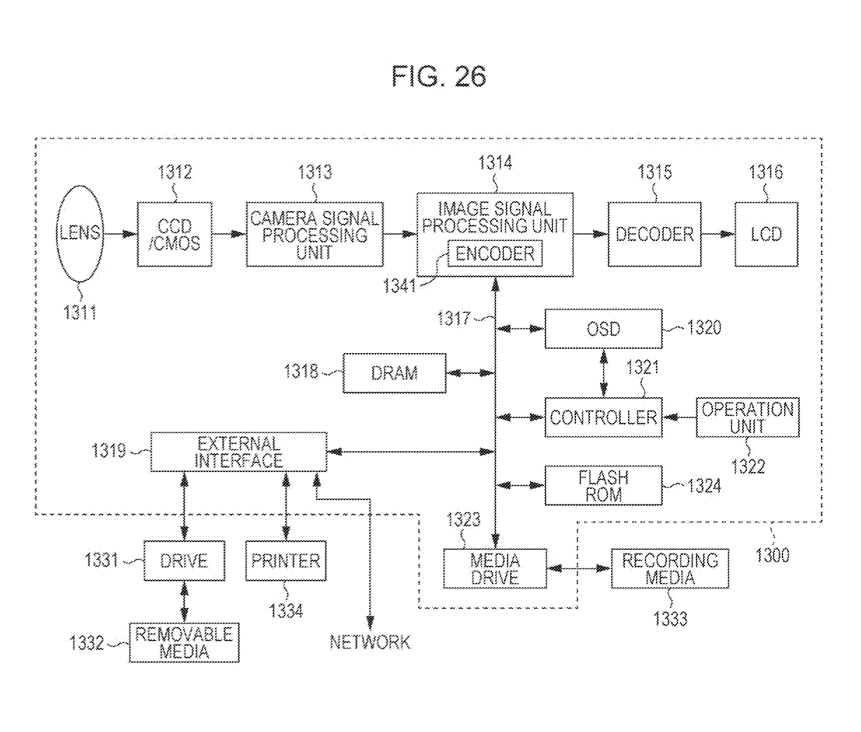

FIG. 26 is a block diagram showing a main configuration example of camera using the image encoding device 300 and image decoding device 400.

The camera 1300 shown in FIG. 26 captures the image of a subject, displays the image of the subject on and LCD 1316, and records this on a recording medium 1333 as image data.

A lens block 1311 causes light (that is, video of the subject) to be incident on the CCD/CMOS 1312. The CCD/CMOS 1312 is an image sensor using a CCD or a CMOS, converts the intensity of received light to an electrical signal and provides the signals to a camera signal processing unit 1313.

The camera signal processing unit 1313 converts the electrical signal provided from the CCD/CMOS 1312 to Y, Cr, Cb color difference signals, and provides the signals to an image signal processing unit 1314. The image signal processing unit 1314 performs a predetermined image processing with respect to the image signal provided from the camera signal processing unit 1313 under control of the controller 1321, and encodes the image signal with an encoder 1341. The image signal processing unit 1314 provides encoded data generated by encoding the image signal to the decoder 1315. Furthermore, the image signal processing unit 1314 acquires display data generated in the on screen display (OSD) 1320 and provides the data to the decoder 1315.

In the above process, the camera signal processing unit 1313 appropriately uses a DRAM (Dynamic Random Access Memory) 1318 connected via a bus 1317 and stores as needed image data or encoded data in which the image data is encoded in the DRAM 1318.

The decoder 1315 decodes the encoded data provided from the image signal processing unit 1314, and provides the obtained image data (decoded image data) to the LCD 1316. In addition, the decoder 1315 provides display data provided from the image signal processing unit 1314 to the LCD 1316. The LCD 1316 appropriately synthesizes the image of the decoded image data provided from the decoder 1315 and the image of the display data, and displays the synthesized image.

The on screen display 1320 outputs display data, such as a menu screen formed from symbols, text, or images, or icons, to the image signal processing unit 1314 via the bus 1317 under control of a controller 1321.

The controller 1321 controls the image signal processing unit 1314, DRAM 1318, external interface 1319, on screen display 1320 and media drive 1323 and the like via the bus 1317, along with executing various processes, based on signals indicating content commanded by the user using an operation unit 1322. Programs or data needed in the execution of various processes by the controller 1321 are accommodated in the FLASH ROM 1324.

For example, the controller 1321 encodes the image data stored in the DRAM 1318 rather than in the image signal processing unit 1314 or decoder 1315, and is able to decode the encoded data stored in the DRAM 1318. At this time, the controller 1321 may perform encoding or decoding processes using the same format as the encoding or decoding format of the image signal processing unit 1314 or decoder 1315, or may perform encoding or decoding processes with a format not corresponding to the image signal processing unit 1314 or decoder 1315.

In addition, for example, in the case of the start of image printing is instructed from the operation unit 1322, the controller 1321 reads out the image data from the DRAM 1318 and the data is printed by being provided to a printer 1334 connected to the external interface 1319 via the bus 1317.

Furthermore, for example, in a case in which image recording is instructed from the operation unit 1322, the controller 1321 reads out the encoded data from the DRAM 1318 and the data is stored by being provided to the recording medium 1333 attached to the media drive 1323 via the bus 1317.

The recording medium 1333 is a rewritable arbitrary removable medium, such as, for example, a magnetic disk, a magneto-optical disc, an optical disc or a semiconductor memory. The recording medium 1333 naturally has an arbitrary type as a removable medium, and may be a tape device, may be a disk or may be a memory card. Naturally, a contactless IC card or the like may be used.

In addition, the media drive 1323 and the recording medium 1333 may be integrated, and, for example, may be configured by a non-transportable storage medium, such as a built-in hard disk drive or SSD (Solid State Drive), or the like.

The external interface 1319 is configured of, for example, a USB input and output terminal, or the like, and in the case of performing printing of an image, is connected to a printer 1334. In addition, a drive 1331 is connected to the external interface 1319 as needed, a removable medium 1332, such as a magnetic disk, optical disc, magneto-optical disc or the like is appropriately equipped, and a computer program read out therefrom is installed to the FLASH ROM 1324 as needed.

Furthermore, the external interface 1319 includes a network interface connected to a predetermined network, such as a LAN or the Internet. The controller 1321, for example according to instructions from the operation unit 1322, reads out encoded data from the DRAM 1318, and may provide the data to another device connected to the network from the external interface 1319. In addition, the controller 1321 acquires encoded data or image data provided from another device via the network via the external interface 1319 and is able to store the data in the DRAM 1318 and provide the data to the image signal processing unit 1314.

The camera 1300 such as above uses the image decoding device 400 as the decoder 1315. That is, the decoder 1315, similarly to the case of the image decoding device 400, reconstructs the prediction Predictor information of the current PU from the Predictor information of the peripheral PU, reconstructs the prediction motion information of the current PU using this reconstructed prediction Predictor information, reconstructs the motion information of the current PU using this reconstructed prediction motion information, performs motion compensation using this reconstructed motion information and appropriately generates an inter encoded prediction image. Accordingly, the decoder 1315 is able to appropriately decode encoded data generated using a mode predicting the Predictor of the current PU from the Predictor of the peripheral PU in the encoding side. In so doing, the decoder 1315 is able to realize improvement in encoding efficiency.

Accordingly, the camera 1300 is able to realize improvements in the encoding efficiency of, for example, image data generated in the CCD/CMOS 1312, encoded data of video data read out from the DRAM 1318 or the recording medium 1333 or video data acquired via the network.

In addition, the camera 1300 uses the image encoding device 300 as the encoder 1341. The encoder 1341, similarly to the case of the image encoding device 300, generates a prediction image in a mode predicting the Predictor of the current PU from the Predictor of the peripheral PU, and generates encoded data using the prediction image.

Accordingly, the encoder 1341 is able to not perform encoding of the Predictor information. In so doing, the encoder 1341 is able to realize improvements in encoding efficiency.

Accordingly, the camera 1300, for example, is able to realize an improvement in the encoding efficiency of the encoded data recorded in, for example, the DRAM 1318 or the recording medium 1333, or encoded data provided to another device.

Moreover, the decoding method of the image decoding device 400 may be applied to the decoding method performed by the controller 1321. Similarly, the encoding method of the image encoding device 300 may be applied to the encoding process performed by the controller 1321.

In addition, the image data captured by the camera 1300 may be a moving image, or may be a still image.

Naturally, the image encoding device 300 and the image decoding device 400 are applicable to devices or systems other than the above-described device.

The present technology may be applied to image encoding devices or image decoding devices used when receiving image information (bit stream) compressed by an orthogonal transform, such as a discrete cosine transform and motion compensation, as in MPEG, H.26× or the like, via a network medium, such as satellite broadcast, cable TV, the Internet or a portable telephone, or when processing on a storage medium, such as an optical or magnetic disk or flash memory.

Here, the present technique may also adopt the following configuration.

(1) An image processing device including a predictor prediction unit predicting a predictor used in a current block from information of a predictor used in a peripheral block positioned in the periphery of the current block which is an encoding process target; a prediction image generation unit generating a prediction image of the current block using the predictor of the current block predicted by the predictor prediction unit; and a decoding unit decoding encoded data in which an image is encoded using a prediction image generated by the prediction image generation unit.
(2) The image processing device according to (1), wherein the peripheral block includes an adjacent block adjacent to the current block.
(3) The image processing device according to (2), wherein the adjacent block includes an upper adjacent block adjacent to the upper portion of the current block, and a left adjacent block adjacent to the left portion of the current block.
(4) The image processing device according to (3), wherein the adjacent block further includes an upper left adjacent block adjacent to the upper left portion of the current block, or an upper right adjacent block adjacent to the upper right portion of the current block.
(5) The image processing device according to (2) to (4), wherein the peripheral block further includes a Co-located block positioned Co-located with the current block.
(6) The image processing device according to (1) to (5), wherein the predictor prediction unit sets the predictor with the smallest index within the predictor of the peripheral block to the prediction result of the predictor of the current block.
(7) The image processing device according to (1) to (6), wherein the predictor prediction unit, in a case where a part of a peripheral block is not present, predicts the predictor of the current block using only the predictor of present peripheral blocks, and in a case where all peripheral blocks are not present, skips prediction of the predictor of the current block.
(8) The image processing device according to (1) to (7), wherein the predictor prediction unit predicts the predictor of the current block using only a predictor of a peripheral block with a size matching or approximating the current block, and skips prediction of the predictor of the current block in a case where a size of all peripheral blocks does not match and does not approximate the current block.
(9) The image processing device according to (1) to (8), wherein the predictor prediction unit, in a case where a part of the peripheral block is encoded using a MergeFlag, predicts the predictor of the current block using an index signifying motion information of a peripheral block different to a merged peripheral block.
(10) The image processing device according to (1) to (9), wherein the predictor prediction unit, in a case where the peripheral block is intra encoded, predicts the predictor of the current block with a code number with respect to a predictor of the peripheral block as 0.
(11) An image processing method of an image processing device, the method including causing a predictor prediction unit to predict a predictor used in the current block from information of a predictor used in a peripheral block positioned in the periphery of the current block which is an encoding process target; causing a prediction image generation unit to generate a prediction image of the current block using the predictor of the predicted current block; and causing a decoding unit to decode encoded data in which an image is encoded using a generated prediction image.
(12) An image processing device including a predictor prediction unit predicting a predictor used in the current block from information of a predictor used in a peripheral block positioned in the periphery of the current block which is an encoding process target; a prediction image generation unit generating a prediction image of the current block using the predictor of the current block predicted by the predictor prediction unit; and an encoding unit encoding an image using a prediction image generated by the prediction image generation unit.
(13) The image processing device according to (12), wherein the peripheral block includes an adjacent block adjacent to the current block.
(14) The image processing device according to (13), wherein the adjacent block includes an upper adjacent block adjacent to the upper portion of the current block, and a left adjacent block adjacent to the left portion of the current block.
(15) The image processing device according to (14), wherein the adjacent block further includes an upper left adjacent block adjacent to the upper left portion of the current block, or an upper right adjacent block adjacent to the upper right portion of the current block.
(16) The image processing device according to (12) to (15), wherein the peripheral block further includes a Co-located block positioned Co-located with the current block.
(17) The image processing device according to (12) to (16), wherein the predictor prediction unit sets the predictor with the smallest index within the predictor of the peripheral block to the prediction result of the predictor of the current block.
(18) The image processing device according to (12) to (17), wherein the predictor prediction unit, in a case where a part of a peripheral block is not present, predicts the predictor of the current block using only the predictor of present peripheral blocks, and in a case where all peripheral blocks are not present, skips prediction of the predictor of the current block.
(19) The image processing device according to (12) to (17), wherein the predictor prediction unit predicts the predictor of the current block using only a predictor of a peripheral block with a size matching or approximating the current block, and skips prediction of the predictor of the current block in a case where a size of all peripheral blocks does not match and does not approximate the current block.
(20) The image processing device according to (12) to (19), wherein the predictor prediction unit, in a case where a part of the peripheral block is encoded using a MergeFlag, predicts the predictor of the current block using an index signifying motion information of a peripheral block different to a merged peripheral block.
(21) The image processing device according to (12) to (20), further including a comparison unit comparing a predictor with respect to the current block and a predictor predicted by the predictor prediction unit; and a flag information generation unit generating flag information representing a comparison result by the comparison unit.
(22) The image processing device according to (21), wherein the encoding unit encodes the flag information generated by the flag information generating unit together with the information related to predictor predicted by the predictor prediction unit, or the difference between a predictor predicted by the predictor prediction unit and a predictor with respect to the current block.
(23) The image processing device according to (12) to (22), wherein the predictor prediction unit, in a case where the peripheral block is intra encoded, predicts the predictor of the current block with a code number with respect to a predictor of the peripheral block as 0.
(24) An image processing method of an image processing device, the method includes causing a predictor prediction unit to predict a predictor used in the current block from information of a predictor used in a peripheral block positioned in the periphery of the current block which is an encoding process target; causing a prediction image generation unit to generate a prediction image of the current block using the predictor of the predicted current block; and causing an encoding unit to encode an image using a generated prediction image.

### REFERENCE SIGNS LIST

300 image encoding device
315 motion prediction and compensation unit
321 motion information prediction unit
331 motion search unit
332 cost function calculation unit
333 mode determination unit
334 motion compensation unit
335 motion information buffer
341 motion prediction unit
342 Predictor prediction unit
343 comparison determination unit
344 flag generation unit 344
400 image decoding device
412 motion prediction and compensation unit
421 motion information prediction unit
431 optimal mode information buffer
432 mode determination unit 432
433 motion information reconstruction unit
434 motion compensation unit
435 motion information buffer
441 prediction Predictor information reconstruction unit
442 prediction motion information reconstruction unit
443 Predictor information buffer

1. An image processing device comprising:
a predictor prediction unit predicting a motion vector predictor used in a current block from information of a motion vector predictor used in a prediction of a motion vector in a peripheral block positioned in the periphery of the current block;
a prediction image generation unit generating a prediction image of the current block using the motion vector predictor of the current block predicted by the predictor prediction unit; and
a decoding unit decoding encoded data in which an image is encoded using a prediction image generated by the prediction image generation unit.

2. The image processing device according to claim 1, wherein the prediction image generation unit, in a case where the predicted value of the motion vector predictor predicted by the predictor prediction unit and the value of the motion predictor of the current block are different, generates a prediction image of the current block using the motion vector predictor of the current block.

3. The image processing device according to claim 2, wherein the predictor of the motion vector of the current block, in a case where the predicted value of the motion vector predictor predicted by the predictor prediction unit and the value of the motion vector predictor of the current block are different, is transmitted as the encoded stream, and
the prediction image generation unit generates a prediction image of the current block using a motion vector predictor of the current block transmitted as the encoded stream.

4. The image processing device according to claim 3, wherein identification information identifying that the predicted value of a motion vector predictor predicted by the predictor prediction unit and the value of a motion vector predictor of a current block match is transmitted as an encoded stream, and
the prediction image generation unit, in a case where the identification information shows that a predicted value of a motion vector predictor predicted by the predictor prediction unit and the value of a motion vector predictor of a current block match, generates a prediction image of the current block using a predicted value of a motion vector predictor predicted by the predictor prediction unit.

5. The image processing device according to claim 1, wherein the peripheral block includes an adjacent block adjacent to the current block.

6. The image processing device according to claim 5, wherein the peripheral block further includes a Co-located block positioned Co-located with the current block.

7. The image processing device according to claim 1, wherein the predictor prediction unit sets the predictor with the smallest index within the predictor of the peripheral block to the prediction result of the predictor of the current block.

8. The image processing device according to claim 1, wherein the predictor prediction unit, in a case where a part of a peripheral block is not present, predicts the predictor of the current block using only the predictor of present peripheral blocks, and in a case where all peripheral blocks are not present, skips prediction of the predictor of the current block.

9. The image processing device according to claim 1, wherein the predictor prediction unit predicts the predictor of the current block using only a predictor of a peripheral block with a size matching or approximating the current block, and skips prediction of the predictor of the current block in a case where a size of all peripheral blocks does not match and does not approximate the current block.

10. The image processing device according to claim 1, wherein the predictor prediction unit, in a case where a part of the peripheral block is encoded using a MergeFlag, predicts the predictor of the current block using an index signifying motion information of a peripheral block different to a merged peripheral block.

11. An image processing method of an image processing device, the method comprising:
causing a predictor prediction unit to predict a motion vector predictor used in the current block from information of a motion vector predictor used in prediction of a motion vector in a peripheral block positioned in the periphery of a current block;
causing a prediction image generation unit to generate a prediction image of the current block using the motion vector predictor of the predicted current block; and
causing a decoding unit to decode encoded data in which an image is encoded using a generated prediction image.

12. An image processing device comprising:
a predictor prediction unit predicting a motion vector predictor used in the current block from information of a motion vector predictor used in a prediction of a motion vector in a peripheral block positioned in the periphery of the current block;
a prediction image generation unit generating a prediction image of the current block using the motion vector predictor of the current block predicted by the predictor prediction unit; and
an encoding unit encoding an image using a prediction image generated by the prediction image generation unit.

13. The image processing device according to claim 12, wherein the predictor prediction unit sets the predictor with the smallest index within the predictor of the peripheral block to the prediction result of the predictor of the current block.

14. The image processing device according to claim 12, wherein the prediction image generation unit, in a case where the predicted value of the motion vector predictor predicted by the predictor prediction unit and the value of the motion predictor of the current block are different, generates a prediction image of the current block using the motion vector predictor of the current block.

15. The image processing device according to claim 14, wherein the predictor of the motion vector of the current block, in a case where the predicted value of the motion vector predictor predicted by the predictor prediction unit and the value of the motion vector predictor of the current block are different, is transmitted as the encoded stream, and
the prediction image generation unit generates a prediction image of the current block using a motion vector predictor of the current block transmitted as the encoded stream.

16. The image processing device according to claim 15, wherein identification information identifying that the predicted value of a motion vector predictor predicted by the predictor prediction unit and the value of a motion vector predictor of a current block match is transmitted as an encoded stream, and
the prediction image generation unit, in a case where the identification information shows that a predicted value of a motion vector predictor predicted by the predictor prediction unit and the value of a motion vector predictor of a current block match, generates a prediction image of the current block using a predicted value of a motion vector predictor predicted by the predictor prediction unit.

17. The image processing device according to claim 12, further comprising:
a comparison unit comparing a predictor with respect to the current block and a predictor predicted by the predictor prediction unit; and
a flag information generation unit generating flag information representing a comparison result by the comparison unit.

18. The image processing device according to claim 17, wherein the encoding unit encodes the flag information generated by the flag information generating unit together with the information related to predictor predicted by the predictor prediction unit, or the difference between a predictor predicted by the predictor prediction unit and a predictor with respect to the current block.

19. An image processing method of an image processing device, the method comprising:
causing a predictor prediction unit to predict a motion vector predictor used in the current block from information of a motion vector predictor used in prediction of a motion vector in a peripheral block positioned in the periphery of a current block;
causing a prediction image generation unit to generate a prediction image of the current block using the predictor of the predicted current block; and
causing an encoding unit to encode an image using a generated prediction image.

20-24. (canceled)
